(19) United States
(12) Patent Application Publication
(10) Pub. No.: US 2025/0335034 A1
(43) Pub. Date: Oct. 30, 2025

(54) FORCE CONTROL MODULE AND WEARABLE DEVICE COMPRISING THE SAME

(71) Applicant: National University of Singapore, Singapore (SG)

(72) Inventors: Jiaming QI, Singapore (SG); Chwee Teck LIM, Singapore (SG)

(73) Assignee: National University of Singapore, Singapore (SG)

(21) Appl. No.: 18/865,012

(22) PCT Filed: May 3, 2023
(86) PCT No.: PCT/SG2023/050299

§ 371 Date: Nov. 12, 2024

(30) Foreign Application Priority Data
May 13, 2022 (SG) 10202205047P

(51) Int. Cl. G06F 3/01; B33Y 10/00; B33Y 80/00

(52) U.S. Cl. CPC G06F 3/016; G06F 3/014; B33Y 10/00; B33Y 80/00

(57) ABSTRACT

The present disclosure generally relates to a force control module and a wearable device comprising the same. The force control module has a fixed part, a rotational part aligned to the fixed part and rotatable about a rotational axis of the fixed part, and an elastomeric part within the fixed part or rotational part. The elastomeric part is separated from an inner surface of the fixed part or rotational part and is coupled to the rotational part. The elastomeric part is actuatable towards the inner surface to generate a variable actuation force on the inner surface, the variable actuation force for resisting rotation of the rotational part.

### CROSS REFERENCE TO RELATED APPLICATION(S)

The present application is a national phase entry under 35 U.S.C. § 371 of International Application No. PCT/SG2023/050299, filed May 3, 2023, published in English, which claims the benefit of Singapore patent application Ser. No. 10/202,205047P, filed May 13, 2022, the disclosures of which are hereby incorporated by reference.

### TECHNICAL FIELD

The present disclosure generally relates to a force control module and a wearable device comprising the same. More particularly, the present disclosure describes various embodiments of the force control module for generating a variable actuation force, as well as the wearable device for generating haptic feedback from the variable actuation force.

### BACKGROUND

Various wearable devices such as gloves have been developed for applications such as gaming and virtual reality. However, challenges exist in designing wearable devices that provide realistic and immersive experiences to users, such as providing haptic feedback to users engaging in these applications. For example, WO 2018212971 describes a haptic feedback glove acting as a virtual reality human-computer interface, US20210059888 describes an exoskeleton glove to enable a user to interact with virtual objects, and US20210026447 describes a hand exoskeleton force feedback system with applications in virtual reality.

Therefore, in order to address some of these challenges, there is a need to provide an improved wearable device.

### SUMMARY

According to a first aspect of the present disclosure, there is a force control module comprising:
at least one fixed part;
at least one rotational part aligned to the fixed part and rotatable about a rotational axis of the fixed part; and
an elastomeric part disposed within one of the fixed part and rotational part, the elastomeric part separated from an inner surface of the one of the fixed part and rotational part, the elastomeric part coupled to the rotational part such that the elastomeric part is rotatable by the rotational part about the rotational axis,
wherein the elastomeric part is actuatable towards the inner surface to generate a variable actuation force on the inner surface, the variable actuation force for resisting rotation of the rotational part.

According to a second aspect of the present disclosure, there is a wearable device comprising:
a glove comprising a plurality of digit sections;
a plurality of force control modules, each force control module coupled to a respective one of the digit sections and comprising:
   at least one fixed part;
   at least one rotational part aligned to the fixed part and rotatable about a rotational axis of the fixed part;
   an elastomeric part disposed within one of the fixed part and rotational part, the elastomeric part separated from an inner surface of the one of the fixed part and rotational part, the elastomeric part coupled to the rotational part such that the elastomeric part is rotatable by the rotational part about the rotational axis; and
   a cable coupled to the rotational part and the respective digit section for rotating the rotational part in response to movement of the respective digit section; and
a controller module configured for controlling the force control modules to actuate the elastomeric parts towards the inner surfaces to generate variable actuation forces on the inner surfaces, the variable actuation forces for resisting rotations of the elastomeric parts,
wherein the resisted rotations of the rotational parts in response to movement of the digit sections generate haptic feedback in the digit sections.

A force control module and a wearable device comprising the force control module according to the present disclosure are thus disclosed herein. Various features, aspects, and advantages of the present disclosure will become more apparent from the following detailed description of the embodiments of the present disclosure, by way of non-limiting examples only, along with the accompanying drawings.

### BRIEF DESCRIPTION OF THE DRAWINGS

FIGS. 1A to 1E are illustrations of a force control module according to embodiments of the present disclosure.

FIGS. 2A to 2D are illustrations of the force control module when actuated.

FIGS. 3A to 3D are illustrations of various parameters of the force control module.

FIGS. 4A to 4C are further illustrations of the force control module.

FIG. 5 is an illustration of a wearable device comprising the force control modules according to embodiments of the present disclosure.

FIGS. 6A to 6C are illustrations of a pneumatic system of the wearable device.

FIGS. 7A to 7E are illustrations of experiments performed on the force control module.

FIGS. 8A to 8C are illustrations of another wearable device comprising the force control modules.

FIGS. 9A to 9J are illustrations of tests performed on the wearable device.

FIGS. 10A to 10H are illustrations of various virtual reality applications using the wearable device.

FIGS. 11A and 11B are illustrations of a user study of the wearable device.

FIGS. 12A to 12E are illustrations of another user study of the wearable device.

FIG. 13 is an illustration of various applications of the wearable device.

### DETAILED DESCRIPTION

For purposes of brevity and clarity, descriptions of embodiments of the present disclosure are directed to a force control module and a wearable device comprising the force control module, in accordance with the drawings. While aspects of the present disclosure will be described in conjunction with the embodiments provided herein, it will be understood that they are not intended to limit the present disclosure to these embodiments. On the contrary, the present disclosure is intended to cover alternatives, modifications and equivalents to the embodiments described herein, which are included within the scope of the present disclosure as defined by the appended claims. Furthermore, in the following detailed description, specific details are set forth in order to provide a thorough understanding of the present disclosure. However, it will be recognized by an individual having ordinary skill in the art, i.e. a skilled person, that the present disclosure may be practiced without specific details, and/or with multiple details arising from combinations of aspects of particular embodiments. In a number of instances, well-known systems, methods, procedures, and components have not been described in detail so as to not unnecessarily obscure aspects of the embodiments of the present disclosure.

In embodiments of the present disclosure, depiction of a given element or consideration or use of a particular element number in a particular figure or a reference thereto in corresponding descriptive material can encompass the same, an equivalent, or an analogous element or element number identified in another figure or descriptive material associated therewith.

References to “an embodiment/example”, “another embodiment/example”, “some embodiments/examples”, “some other embodiments/examples”, and so on, indicate that the embodiment(s)/example(s) so described may include a particular feature, structure, characteristic, property, element, or limitation, but that not every embodiment/example necessarily includes that particular feature, structure, characteristic, property, element or limitation. Furthermore, repeated use of the phrase “in an embodiment/example” or “in another embodiment/example” does not necessarily refer to the same embodiment/example.

The terms “comprising”, “including”, “having”, and the like do not exclude the presence of other features/elements/steps than those listed in an embodiment. Recitation of certain features/elements/steps in mutually different embodiments does not indicate that a combination of these features/elements/steps cannot be used in an embodiment.

As used herein, the terms “a” and “an” are defined as one or more than one. The use of “/” in a figure or associated text is understood to mean “and/or” unless otherwise indicated. The term “set” is defined as a non-empty finite organization of elements that mathematically exhibits a cardinality of at least one (e.g. a set as defined herein can correspond to a unit, singlet, or single-element set, or a multiple-element set), in accordance with known mathematical definitions. The recitation of a particular numerical value or value range herein is understood to include or be a recitation of an approximate numerical value or value range. The terms “first”, “second”, etc. are used merely as labels or identifiers and are not intended to impose numerical requirements on their associated terms.

### Force Control Module

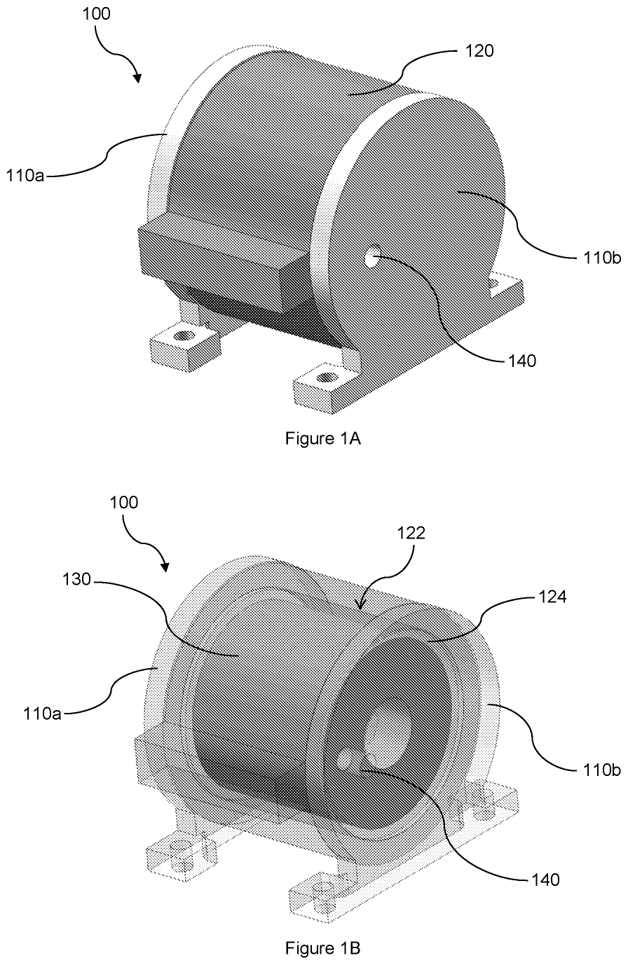

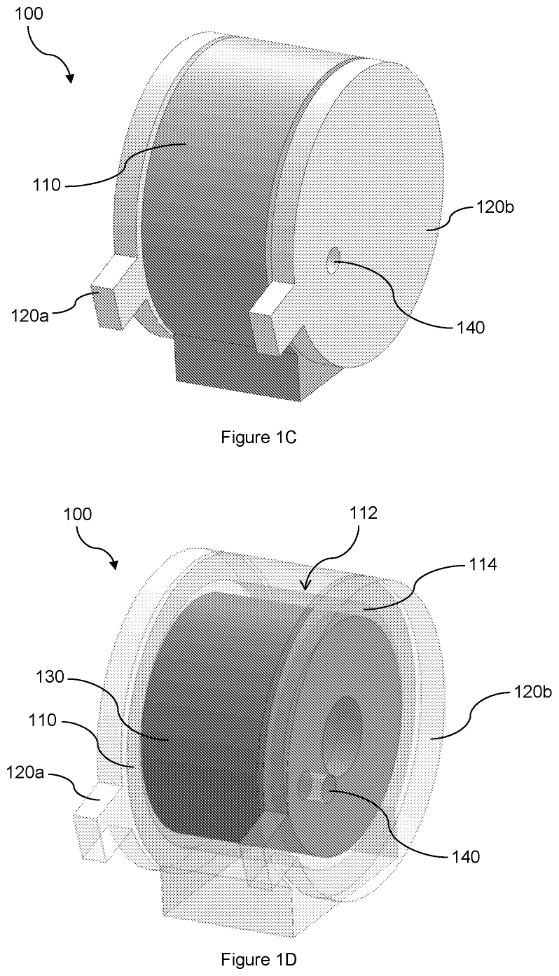

In representative or exemplary embodiments of the present disclosure, there is a force control module 100 as shown in FIGS. 1A to 1E. The force control module 100 includes a set of or at least one fixed part 110, and a set of or at least one rotational part 120 aligned to the fixed part 110 and rotatable about a rotational axis of the fixed part 110. The force control module 100 further includes an elastomeric part 130 disposed within one of the fixed part 110 and rotational part 120. Further, the elastomeric part 130 is separated from an inner surface 112/122 of the one of the fixed part 110 and rotational part 120. The elastomeric part 130 is coupled to the rotational part 120 such that the elastomeric part 130 is rotatable by the rotational part 120 about the rotational axis. The elastomeric part 130 is actuatable towards the inner surface 112/122 to generate a variable actuation force on the inner surface 112/122, the variable actuation force for resisting rotation of the rotational part 120.

More specifically, in the unactuated state, the elastomeric part 130 is separated from the inner surface 112/122 by a clearance 114/124 and is freely rotatable by the rotational part 120. When the elastomeric part 130 is actuated towards the inner surface 112/122, the elastomeric part 130 compresses and exerts an actuation force against the inner surface 112/122. The elastomeric part 130 is made of an elastomeric material such as rubber or silicone (e.g. Ecoflex™). The actuation force is variable depending on the magnitude of the actuation and thus the compression against the inner surface 112/122. The variable actuation force in turn causes a variable frictional force between the elastomeric part 130 and the inner surface 112/122, wherein the variable frictional force impedes rotation of the rotational part 120, since the rotational part 120 are coupled to the elastomeric part 130.

In some embodiments, the elastomeric part 130 is inflatable towards the inner surface 112/122. For example, elastomeric part 130 has a hollow ring shape as shown in FIGS. 1B and 1D. The force control module 100 includes a set of inlets 140 for inflating the elastomeric part 130. When the elastomeric part 130 is inflated with a pressurized fluid 132 such as compressed air, the elastomeric part 130 expands and overrides the clearance 114/124 and subsequently compresses against the inner surface 112/122.

In some embodiments as shown in FIGS. 1A and 1B, the force control module 100 includes a single rotational part 120 disposed between two fixed parts 110. More specifically, the force control module 100 includes a first fixed part 110a and a second fixed part 110b disposed on both sides of the rotational part 120. Alternatively, the force control module 100 includes a single rotational part 120 and a single fixed part 110, wherein the rotational part 120 is coupled to the fixed part 110 such that the rotational part 120 is rotatable about the rotational axis. The elastomeric part 130 is disposed within the rotational part 120 and is separated from the inner surface 122 of the rotational part 120. There is a clearance 124 between the elastomeric part 130 and the inner surface 122. The elastomeric part 130 is inflatable towards the inner surface 122 to override the clearance 124 and subsequently compress against the inner surface 122. The inlets 140 may be disposed on one or both of the first fixed part 110a and second fixed part 110b.

In some embodiments as shown in FIGS. 1C to 1E, the force control module 100 includes a first rotational part 120a and a second rotational part 120b disposed on both sides of the fixed part 110. The first rotational part 120a and second rotational part 120b are rotatable in tandem about the rotational axis. Alternatively, the force control module 100 includes a single rotational part 120 disposed on one side of the fixed part 110. The elastomeric part 130 is disposed within the fixed part 110 and is separated from the inner surface 112 of the fixed part 110. There is a clearance 114 between the elastomeric part 130 and the inner surface 112. The elastomeric part 130 is inflatable towards the inner surface 112 to override the clearance 114 and subsequently compress against the inner surface 112. The inlets 140 may be disposed on one or both of the first rotational part 120a and second rotational part 120b.

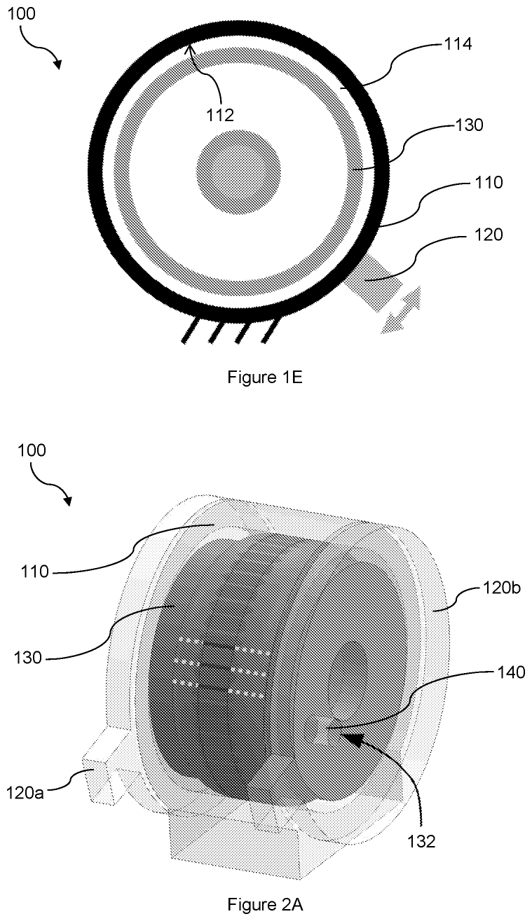

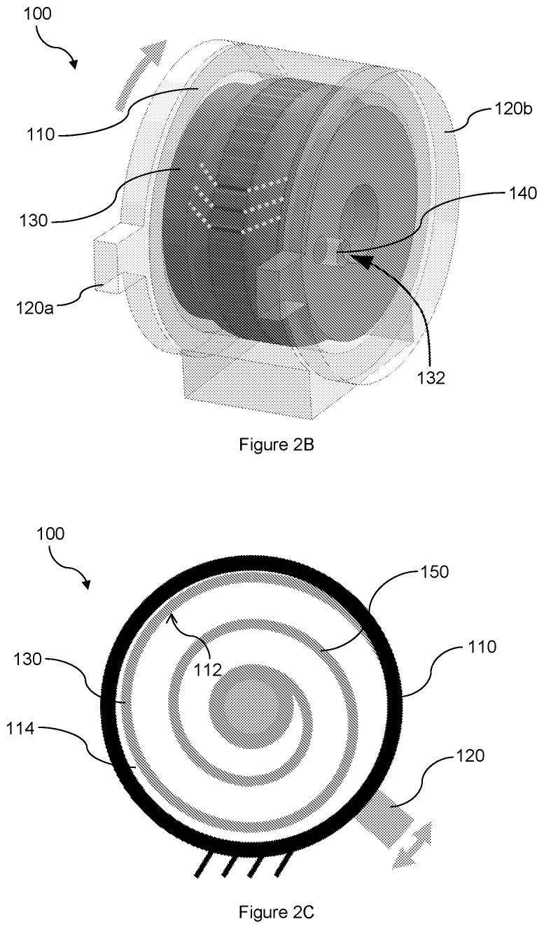

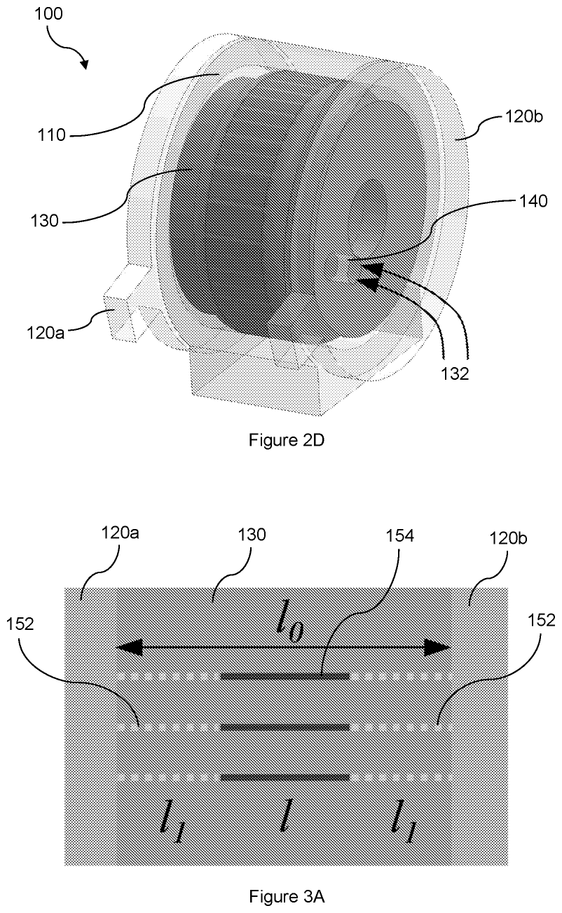

Further as shown in FIGS. 2A to 2C, the elastomeric part 130 is actuated and compressed against the inner surface 112 and an actuation force is generated on the inner surface 112. When the rotational parts 120 are rotated by a rotation angle θ under resistance of the actuated elastomeric part 130, the rotational parts 120 shift the respective sides of the actuated elastomeric part 130 relative to the middle of the elastomeric part 130 which is compressed against the inner surface 112. More specifically, in the embodiment as shown in FIGS. 2A to 2C, the first rotational part 120a and second rotational part 120b are coupled to both sides of the actuated elastomeric part 130, respectively, and rotate in tandem by the rotation angle θ and shift the respective sides of the actuated elastomeric part 130, as indicated by the reference lines 152. The middle of the elastomeric part 130 is compressed against the inner surface 112, with the contact area between them indicated by the reference lines 154. The actuated elastomeric part 130 acts like a torsion spring 150 that resists the rotation of the rotational parts 120. Notably, as shown in FIG. 2D, the contact area with the inner surface 112 would increase if the magnitude of the actuation of the elastomeric part 130 increases, such as by pumping more pressurized fluid 132 into the elastomeric part 130 to increase the inflation pressure.

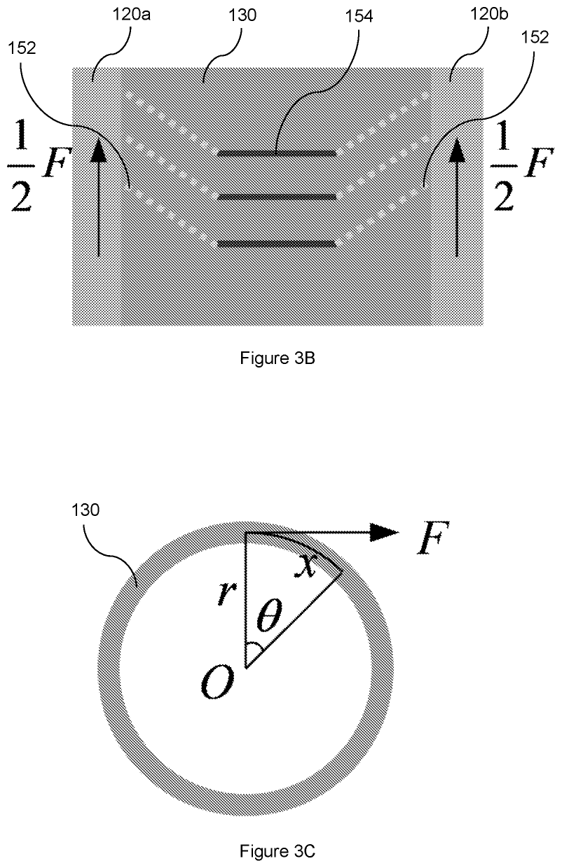

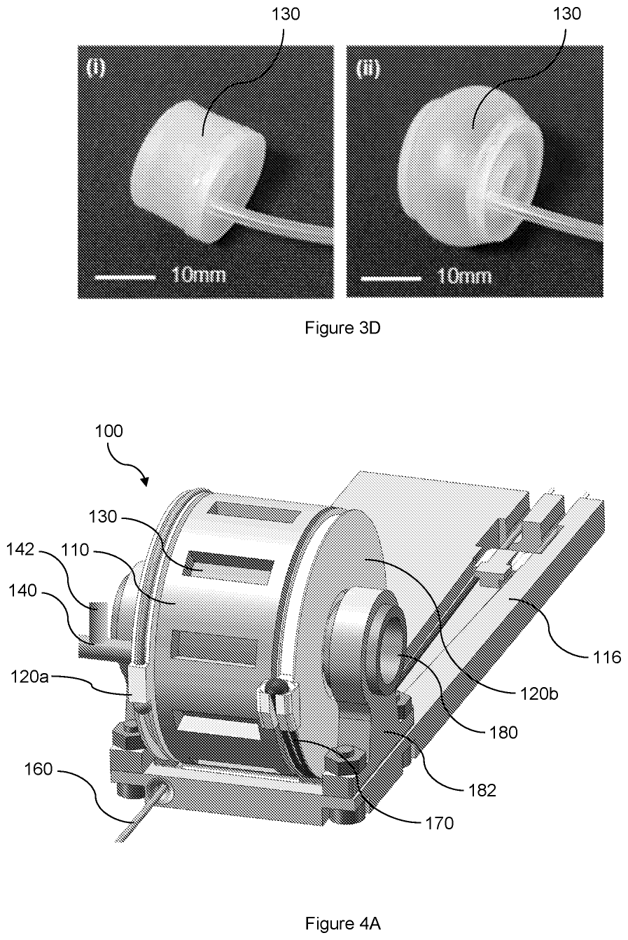

Further as shown in FIGS. 3A to 3D, a torque T₁ is applied to each rotational part 120 to rotate it by the rotation angle θ and shift the respective side of the actuated elastomeric part 130. The contact area remains still and the sides of the elastomeric part 130 (non-contact area) have been shifted by rotation of the respective rotational part 120, which causes shear stress in the non-contact area and contributes to the torque T₁. The torque T₁ can be derived using Equations 1 to 4, wherein k denotes the rotational stiffness, G denotes the shear modulus, J denotes the polar moment of inertia of the combined structure of the respective rotation part 120 and actuated elastomeric part 130. l₁ denotes the length of the respective side of the actuated elastomeric part 130, i.e. the non-contact area, that has been shifted by the respective rotational part 120. Since the torques T₁ are applied to the first rotational part 120a and second rotational part 120b, the total torque T applied to the rotational parts 120 is the sum of the individual torques T₁.

$${T}_{1} = k θ \qquad ( 1 )$$

$$k = \frac{GJ}{{l}_{1}} \qquad ( 2 )$$

$${T}_{1} = ( \frac{GJ}{{l}_{1}} ) θ \qquad ( 3 )$$

$$T = 2 {T}_{1} = 2 ( \frac{GJ}{{l}_{1}} ) θ \qquad ( 4 )$$

The total torque T can also be derived using Equation 5, wherein F represents the total force applied to the rotational parts 120 and r represents the radius from the rotational axis to the applied force F. The rotation angle θ can be derived using Equation 6, wherein x denotes the arc length shifted by each respective side of the actuated elastomeric part 130. The length of each respective side l₁ can be derived using Equation 7, wherein l₀ denotes the total length of the elastomeric part 130 and l denotes the length of the middle of the elastomeric part 130 that is actuated against the inner surface 112.

$$T = Fr \qquad ( 5 )$$

$$θ = \frac{x}{r} \qquad ( 6 )$$

$${l}_{1} = \frac{1}{2} ( {l}_{0} - l ) \qquad ( 7 )$$

From the above equations, the applied force F can be derived as shown in Equations 8 and 9.

$$F = \frac{T}{r} = \frac{2 {T}_{1}}{r} = 2 ( \frac{GJ}{{l}_{1}} ) ( \frac{θ}{r} ) \qquad ( 8 )$$

$$F = 2 ( \frac{GJ}{\frac{1}{2} ( {l}_{0} - l )} ) ( \frac{x}{{r}^{2}} ) = ( \frac{4 GJ}{{r}^{2} ( {l}_{0} - l )} ) x = Sx \qquad ( 9 )$$

Notably, the applied force F is proportional to the arc length x by a stiffness parameter S, which is equivalent to linear stiffness of the combined structure of the rotational parts 120 and the actuated elastomeric part 130. The length l is the only parameter that changes the stiffness parameter S, and the length l is positively correlated with the actuation force of the elastomeric part 130 on the inner surface 112. Notably, the length l in the embodiment as shown in FIG. 2D is longer because of higher actuation force. Hence, by varying the actuation force such as by varying the inflation pressure in the elastomeric part 130, the stiffness parameter S and consequently the applied force F can be varied accordingly, thereby providing variable resistance against rotation of the rotational parts 120. The variable actuation force and resistance can be used to generate force feedback from the force control module 100, as described further below.

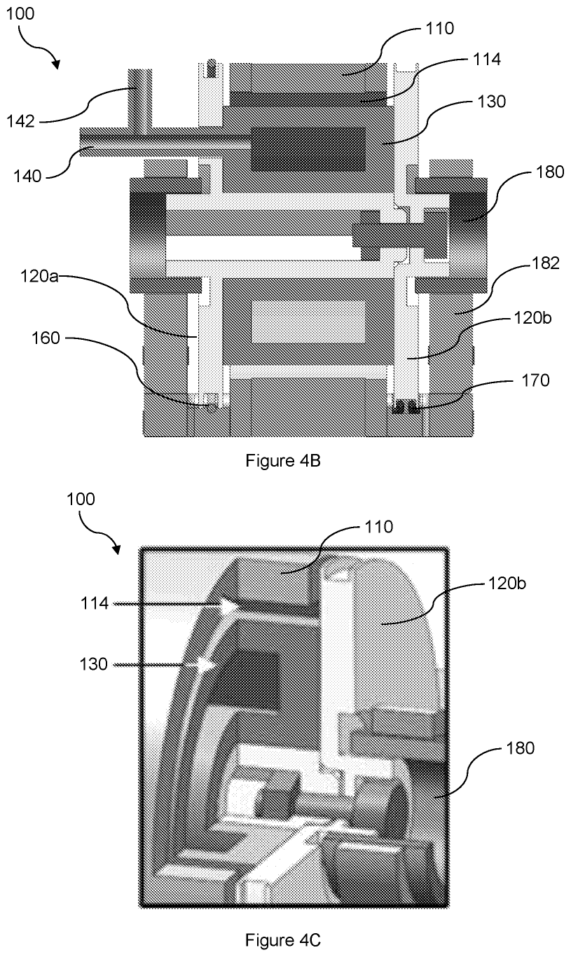

In some embodiments as shown in FIGS. 4A to 4C, the force control module 100 may further include a cable 160 coupled to the rotational parts 120 for rotating the rotational parts 120. For example, the cable 160, such as one comprising a Dyneema® wire, may be coupled to the first rotational part 120a at one end of the cable 160, and the other end of the cable 160 may be coupled to an object. The object is moveable to pull the first rotational part 120a and rotate the rotational parts 120 in tandem.

The force control module 100 may further include an elastic member 170 coupled to the fixed part 110 and the rotational parts 120, the elastic member 170 configured to bias the rotational parts 120 to an initial position before rotation thereof. For example, one end of the elastic member 170 may be coupled to a base 116 of the fixed part 110 and the other end of the elastic member 170 may be coupled to the second rotational part 120b. The elastic member 170 may include a rotational sensor for measuring an angle of the rotation. In one embodiment, the elastic member 170 includes a thin polydimethylsiloxane (PDMS) tube that is embedded with a sensing material such as Eutectic Gallium-Indium (EGaIn). The elastic member 170 may have an initial length of 11 mm and an outer diameter of 0.56 mm.

When the rotational parts 120 are rotated such as when the cable 160 is under tension, the elastic member 170 stretches and the rotational sensor can measure the rotation angle, i.e. θ. When the cable 160 is relaxed, the stretched elastic member 170 returns to its initial state and rotates the rotational parts 120 back to the initial position. It will be appreciated that the cable 160 and elastic member 170 may be coupled to the same or different rotational part 120.

The force control module 100 may further include a set of bushings 180 and a set of bushing supports 182. The bushings 180 are coupled to the bushing supports 182 and the rotational parts 120 are rotatable within the bushings 180. As the rotational parts 120 can be 3D printed using a resin material, the high sliding friction coefficient of the resin material would reduce the rotation efficiency of the rotational parts 120. The bushings 180, which are made of a smooth material such as copper, help to reduce the rotational friction of the rotational parts 120.

Various aspects of the force control module 100 are described herein in relation to the embodiments as shown in FIGS. 1C to 1E. It will be appreciated that these aspects apply similarly or analogously to the embodiments as shown in FIGS. 1A and 1B.

The force control module 100 may connect to one or more other force control modules 100 and/or other actuators, such as soft actuators to form a force control device. For example, the force control modules 100 and/or actuators can be fluidically connected by fluidic conduits such as a set of inlets 140 and a set of outlets 142. The force control modules 100 may be connected to a common pressure source with other fluidic components such as valves to selectively control actuation of the force control modules 100, as described below for a wearable device 200. Alternatively, the force control modules 100 may be directed connected to each other without valves, such that the force control modules 100 can be actuated at the same time.

### Wearable Device 200

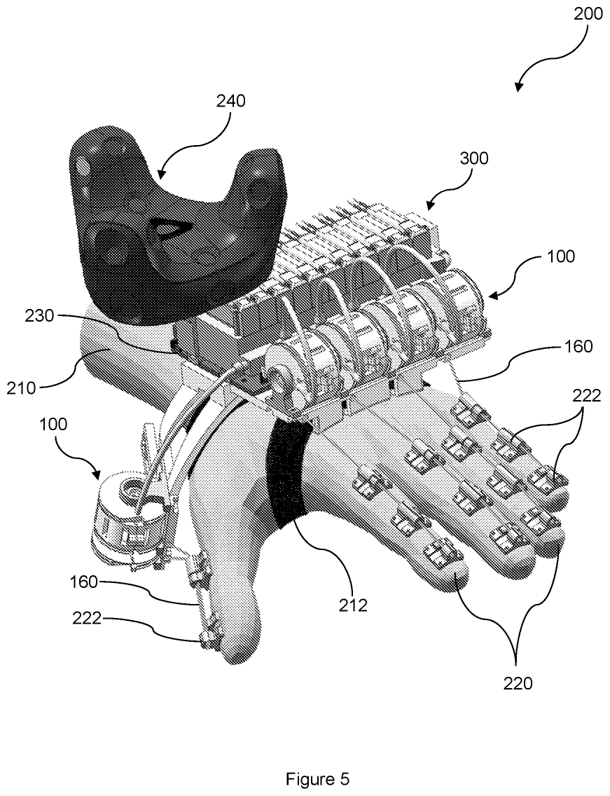

In various embodiments of the present disclosure, there is a wearable device 200 as shown in FIG. 5. The wearable device 200 includes a glove 210 having a plurality of digit sections 220. For example, the glove 210 is a hand glove wearable on a user's hand, and the glove 210 includes five digit sections 220 for the user's fingers including the thumb. The glove 210 may include one or more straps or belts 212 for securing the wearable device 200 on the user's hand. In another example, the glove 210 is a foot glove wearable on a user's foot, wherein the five digit sections 220 are for the user's toes. The glove 210 may be made of a fabric material.

The wearable device 200 further includes a plurality of the force control modules 100 as described above. Each force control module 100 has dimensions of 23 mm×26 mm×70 mm and weighs about 14 g. Each force control module 100 is coupled to a respective one of the digit sections 220 and includes the fixed part 110, rotational parts 120, elastomeric part 130, and cable 160. More specifically, the cable 160 of each force control module 100 is coupled to the respective rotational parts 120 and the respective digit section 220 for rotating the respective rotational parts 120 in response to movement of the respective digit section 220. The wearable device 200 may include a set of cable guides 222 disposed on each digit section 220, such as by sewing on the fabric material of the glove 210, wherein the cable guides 222 guide the coupling of the cable 160 to the respective digit section 220.

Optionally, each digit section 220 may be coupled to a plurality of the force control modules 100. The force control modules 100 for each digit section 220 may share the same fluidic pathway such that they can be inflated and deflated simultaneously with the same inflation pressure.

The wearable device 200 further includes a controller module 230 configured for controlling the force control modules 100 to actuate the elastomeric parts 130 towards the inner surfaces 112/122 to generate variable actuation forces on the inner surfaces 112/122, the variable actuation forces for resisting rotations of the rotational parts 120. The resisted rotations of the rotational parts 120 in response to movement of the digit sections 220 generate haptic feedback in the digit sections 220. For example, when the user's fingers move the digit sections 220, such as by flexion/extension of the fingers, to pull the cables 160 and rotate the rotational parts 120, the user's fingers would feel the haptic feedback from the stiffness of the rotational parts 120 as the rotations are being resisted by the actuation forces.

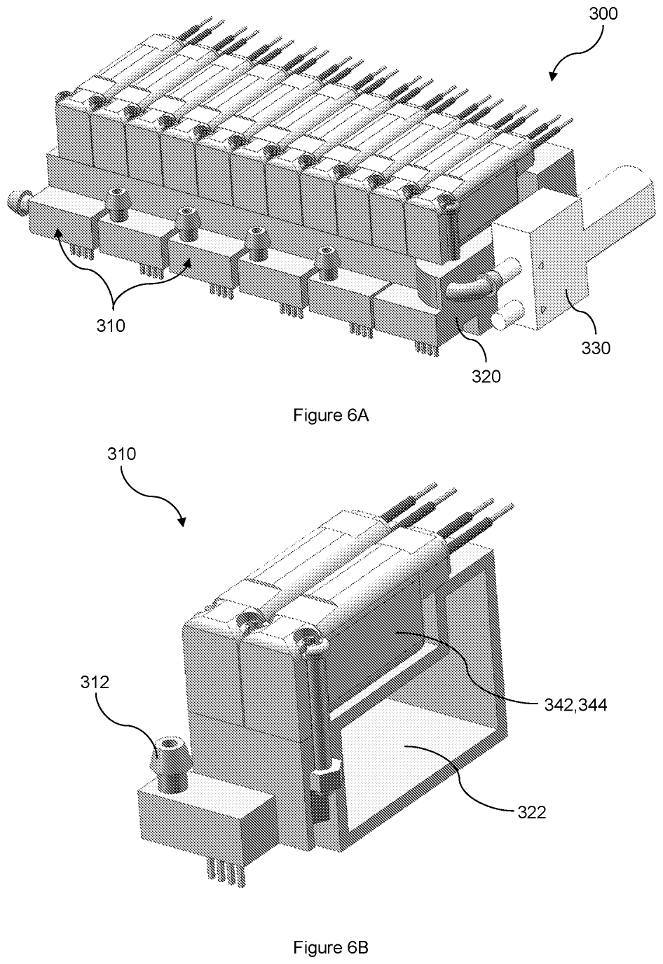

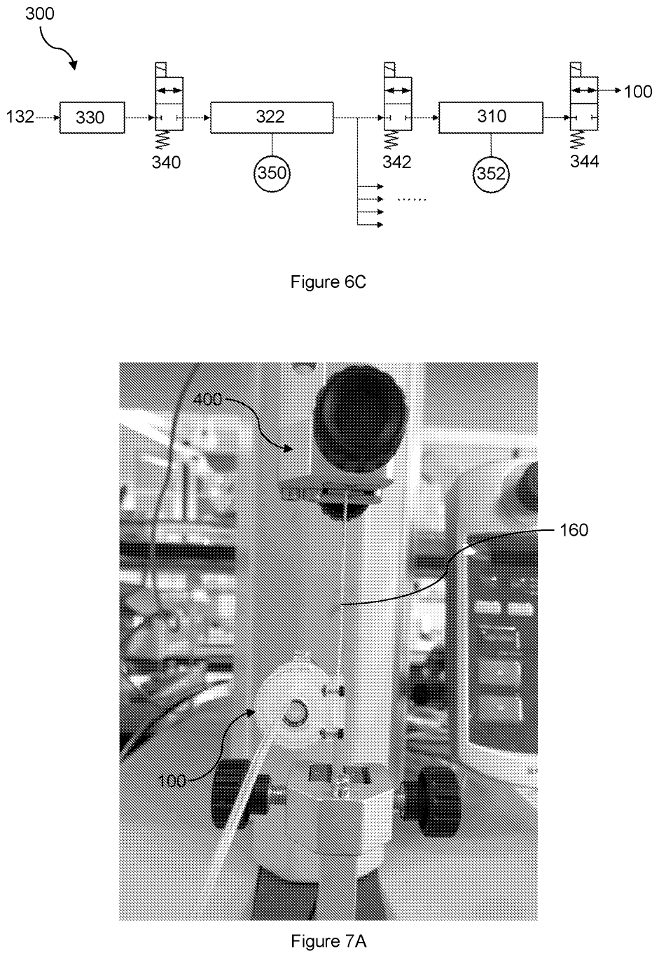

In some embodiments, the wearable device 200 includes a pneumatic system 300 coupled to the force control modules 100 and controllable by the controller module 230 for inflating the elastomeric parts 130 to engage with the inner surfaces 112/122. Further as shown in FIGS. 6A to 6C, the pneumatic system 300 includes a plurality of pneumatic modules 310. Each pneumatic module 310 is coupled to a respective one of the force control modules 100 for inflating the respective elastomeric part 130. More specifically, the controller module 230 is configured to control the communication of the pressurized fluid 132 from the pneumatic modules 310 to the force control modules 100 and regulate inflation pressures in the elastomeric parts 130, thereby regulating the actuation forces and haptic feedback.

The pneumatic system 300 includes a manifold 320 and a pump 330 for communicating the pressurized fluid 132 to the force control modules 100. The manifold 320 includes a chamber 322 for storing the pressurized fluid 132 and communicating the pressurized fluid 132 from the chamber 322 to the pneumatic modules 310 and subsequently to the force control modules 100. The pneumatic system 300 includes a main valve 340, such as a solenoid valve, for regulating communication of the pressurized fluid 132 from the pump 330 to the chamber 322. The pneumatic system 300 includes a primary pressure sensor 350 for measuring the pressure in the chamber 322, such as to determine whether the pressurized fluid 132 in the chamber 322 has reached the desired target pressure.

Each pneumatic module 310 includes a set of connectors 312 for fluidically connecting the respective pneumatic module 310 to the chamber 322 to receive the pressurized fluid 132. For example, the connectors 312 of each pneumatic module 310 are fluidically connected to the chamber 322. Each pneumatic module 310 includes an inlet valve 342 and an outlet valve 344, such as solenoid valves, for regulating communication of the pressurized fluid 132 from the chamber 322 to the respective pneumatic module 310 and subsequently to the respective force control module 100. The inlet valve 342 and outlet valve 344 can thus be controlled to selectively inflate and deflate the elastomeric part 130 of the respective force control module 100. Each pneumatic module 310 includes a secondary pressure sensor 352 for measuring the pressure in the respective pneumatic module 310 which corresponds to the inflation pressure in the respective elastomeric part 130.

The chamber 322 works as a pressurized source for delivering the pressurized fluid 132 to the pneumatic modules 310. The chamber 322 may have an internal volume of about 30 ml. Further, the chamber 322 is configured to maintain a predetermined pressure therein, such as 70 kPa. When the primary pressure sensor 350 measures that the pressure in the chamber 322 is below the predetermined pressure, the pump 330 and main valve 340 will be turned on to deliver the pressurized fluid 132 to the chamber 322 until the chamber 322 reaches the predetermined pressure.

The inflation of the elastomeric parts 130 in the force control modules 100 can be regulated by precisely controlling the opening and closing of the inlet valves 342 and outlet valves 344 of the pneumatic modules 310, typically in the order of microseconds. The inlet valves 342 and outlet valves 344 are calibrated to precisely control the inflation pressure and consequently the haptic feedback. The haptic feedback is also energy efficient as the inlet valves 342 and outlet valves 344 act only when the haptic information changes, such as on the time points of grasping or releasing a virtual object. When there are no changes in the haptic information, such as when holding the same virtual object, the inlet valves 342 and outlet valves 344 stay closed, keeping the pressurized air in the force control modules 100 and maintaining the haptic feedback without consuming any power.

The wearable device 200 may further include a tracking device 240 for tracking movement of the glove 210. For example, the tracking device 240 is a HTC VIVE® Tracker with a pair of cameras. When the glove 210 is worn such as on the user's hand and the user moves the glove 210, the tracking device 240 tracks the movement of the glove 210. Additionally, the rotational sensors in the elastic members 170 of the force control modules 100 can track the movement of the user's fingers based on the measured rotation angles. More specifically, the tracking device 240 tracks the position and orientation of the palm of the user's hand in six degrees of freedom, and the controller module 230 tracks the position and orientation of the user's fingers, such as the positions of the finger joints, in five degrees of freedom via the rotational sensors in the five force control modules 100. Data points in eleven degrees of freedom can be collectively obtained from the controller module 230 and tracking device 240.

The controller module 230 and tracking device 240 are configured for communicating with a computer system. The controller module 230 and tracking device 240 may communicate with the computer system via known communication protocols, including wireless communication protocols such as Bluetooth. The computer system may have a virtual environment executed therein, such as a gaming program or a virtual reality application. The user may use the wearable device 200 to interact with the virtual environment, such as controlling a digital representation of the user's hand in a game or other virtual tasks. The controller module 230 and tracking device 240 transmit the data points representing the eleven degrees of freedom of the user's hand to the computer system, such as movement of the user's hand wearing the glove 210 is translated to the virtual movement of the digital representation. The controller module 230 and tracking device 240 are thus configured for transmitting movement data to the computer system based on movement of the digit sections 220.

When the user is interacting with the virtual environment, the user may attempt to control the digital representation of the user's hand to handle or pick up a virtual object. Object stiffness data and collision data are obtained and processed by the computer system and transmitted to the wearable device 200 as haptic signals. The controller module 230 receives the haptic signals and controls actuation of the elastomeric parts 130 in the force control modules 100 based on the haptic signals. More specifically, the controller module 230 activates the pneumatic system 300 to inflate the elastomeric parts 130 to the required inflation pressures based on the haptic signals. When the digital representation of the user's hand is handling or picking up the virtual object, the user's fingers would feel realistic haptic feedback as if the user's hand is touching a real object, hence improving the immersive experience for the user. The haptic signals and haptic feedback felt by the user would vary depending on the texture and/or rigidity of the virtual object, such as whether the virtual object is soft or rigid.

Further, the controller module 230 regulates the inflation pressures when there are changes in the haptic signals, such as on the time points of grasping or releasing the virtual object. When there is no change in the haptic signal, such as when the virtual object is continuously being grasped, the same inflation pressures are maintained in the force control modules 100, and the haptic feedback remains constant while consuming no to minimal power, thus improving overall energy efficiency.

The controller module 230 may include a printed circuit board and one or more microcontroller units embedded on the printed circuit board. In some embodiments, the controller module 230 includes a primary microcontroller unit and a secondary microcontroller unit. The primary microcontroller unit is configured for receiving sensor data from the rotational sensors in the force control modules 100. The primary microcontroller unit is further configured for receiving pressure data from the primary pressure sensor 350 and five secondary pressure sensors 352. The primary microcontroller unit may receive the movement and pressure data at a predefined frequency such as 50 Hz. The primary microcontroller unit is further configured for tracking movement of the user's fingers based on the movement data. The primary microcontroller unit is further configured for maintaining the pressure of the pressurized fluid 132 in the chamber 322 at the predetermined pressure. The primary microcontroller unit is communicative with the computer system for transmitting the movement data and receiving the haptic signals.

After receiving the haptic signals, the primary microcontroller unit transmits the haptic signals to the secondary microcontroller unit. For example, the primary and secondary microcontroller units may communicate via a communication protocol such as UART. The secondary microcontroller unit is configured to precisely control the inlet valves 342 and outlet valves 344 of the pneumatic modules 310 in the order of microseconds, thus ensuring fast and consistent inflations of the elastomeric parts 130 in the force control modules 100.

Several experiments were conducted to evaluate the performance of a force control module 100 regarding the force profile and actuation profile of the haptic feedback.

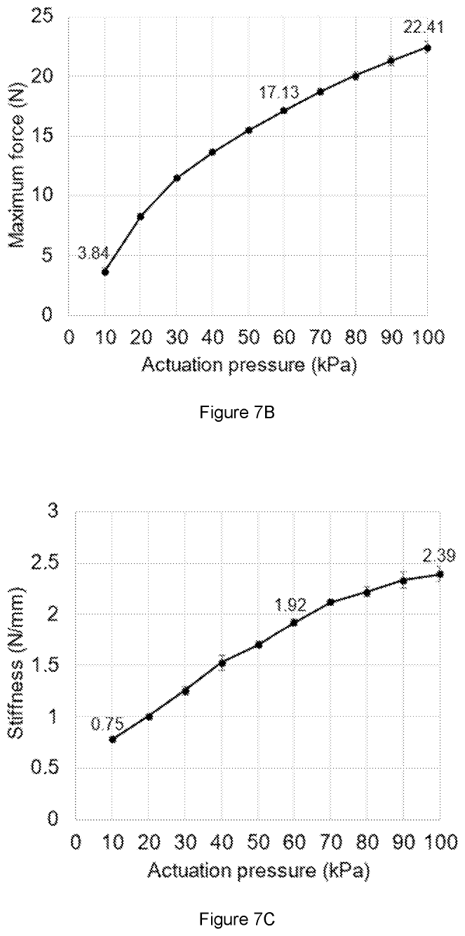

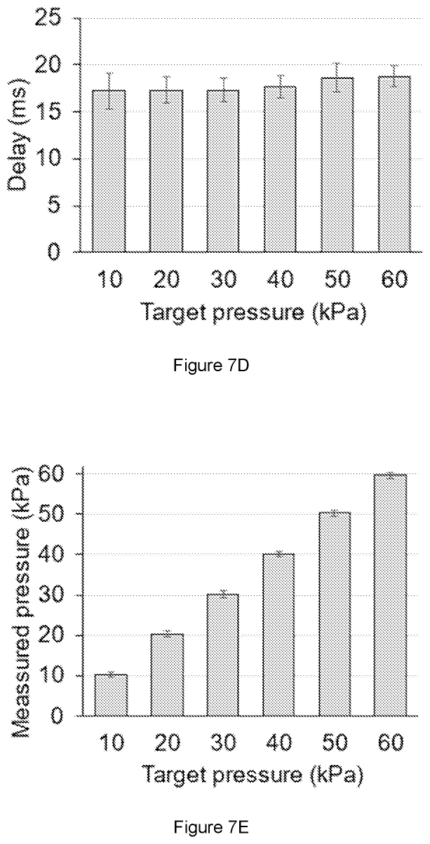

As shown in FIG. 7A, a mechanical tester 400 was used to evaluate the force profile of the haptic feedback generated by the force control module 100. The force control module 100 was clamped tight while the mechanical tester 400 pulled the cable 160 and measured the tension force in the cable 160. Due to biasing force of the elastic member 170, the cable 160 experienced a slight resistance of up to 0.3 N when the elastomeric part 130 is not actuated. The biasing force of the elastic member 170 should be kept as small as possible to minimize its effect on the haptic feedback, such as by using a softer/more elastic material. The elastomeric part 130 of the force control module 100 was actuated to pressures ranging from 10 kPa to 100 kPa. The results for the maximum actuation force and maximum stiffness at these actuation pressures are shown in FIGS. 7B and 7C.

It was observed that the maximum actuation force and maximum stiffness increase as the actuation pressure increases. At 10 kPa actuation pressure, the maximum actuation force is 3.84 N and the maximum stiffness is 0.75 N/mm. At 60 kPa actuation pressure, the maximum actuation force is 17.13 N and the maximum stiffness is 1.92 N/mm. At 100 kPa actuation pressure, the maximum actuation force is 22.41 N and the maximum stiffness is 2.39 N/mm. Hence, for the wearable device 200 with five force control modules 100, the complete haptic feedback for the user's hand can have a maximum stiffness of 9.6 N/mm and a maximum actuation force of 85.65 N at 60 kPa actuation pressure.

The actuation profile of the haptic feedback was evaluated to determine the actuation delay for the pneumatic system 300 to inflate the force control module 100 to the target pressure and to investigate the actuation pressure consistency in the force control module 100 after repetitive actuation. The force control module 100 was inflated to the six target pressures (10 kPa to 60 kPa in 10 kPa increments) and the actuation delay to reach the respective target pressure was measured. The actuation pressures were also measured during the repetitive actuations. The results are shown in FIG. 7D.

Haptic feedback occurs in response to the user's interaction with the virtual environment in real-time. There is usually a visual-haptic time delay between the user seeing an event in the virtual environment and feeling the haptic feedback from the same event. This visual-haptic time delay should be minimized as low as possible to deliver an immersive experience for the user. Some research showed that the threshold for users to perceive the visual event and the haptic feedback as asynchronous is around 45 ms. From the experimental results shown in FIG. 7D, it was found that the actuation delay ranged from 14 ms to 21 ms for the force control module 100 to reach the target pressures of 10 kPa to 60 kPa and generate the haptic feedback. Thus, the force control module 100 is able to provide the user with low-latency haptic feedback.

To evaluate the actuation pressure consistency in the force control module 100, the force control module 100 was subjected to repetitive actuation tests at each of the six target pressures from 10 kPa to 60 kPa. For each target pressure, the actuation pressures were measured and the target and measured actuation pressures are shown in FIG. 7E. The height of each vertical bar denotes the mean of the measured actuation pressures, and the error bar shows the standard deviation. It can be seen that the measured actuation pressures are close to the target pressures with small error bars, demonstrating consistent actuation capability and haptic feedback.

### Wearable Device 500

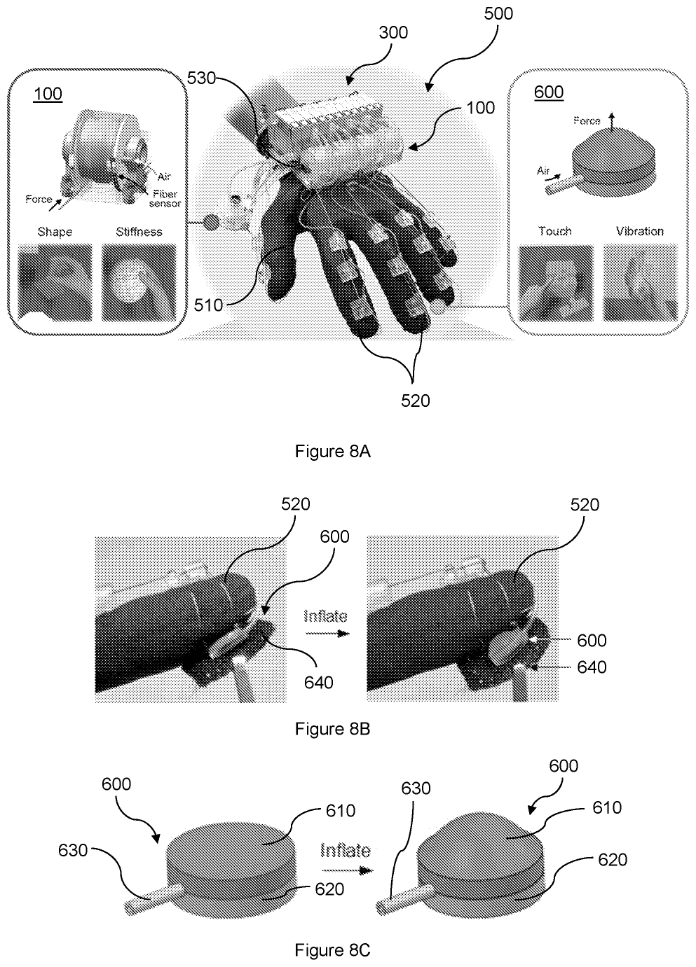

In various embodiments of the present disclosure, there is a wearable device 500 as shown in FIG. 8A. The wearable device 500 includes a glove 510 having a plurality of digit sections 520. The wearable device 500 further includes a plurality of the force control modules 100 as described above. One or more force control modules 100 are coupled to a respective one of the digit sections 520. The wearable device 500 further includes a controller module 530 configured for controlling the force control modules 100. The wearable device 200 further includes the pneumatic system 300 coupled to the force control modules 100 and controllable by the controller module 530. It will be appreciated that various aspects of the wearable device 200 described above apply equally to the wearable device 500.

Further as shown in FIGS. 8B and 8C, the wearable device 500 further includes a plurality of distal force control modules 600. Each distal force control module 600 is coupled to a distal end of a respective one of the digit sections 520. The distal force control module 600 includes a first elastomeric member 610 and a second elastomeric member 620 that are joined together, such as by adhesive or gluing. The first elastomeric member 610 and second elastomeric member 620 have different modulus of elasticity. For example, the first elastomeric member 610 is 9 mm in diameter and 1.5 mm in thickness, and is made of Ecoflex™ 00-50 material. For example, the second elastomeric member 620 is 9 mm in diameter and 1.5 mm in thickness, and is made of PDMS material. As PDMS is stiffer than Ecoflex™, the first elastomeric member 610 is able to expand more than the second elastomeric member 620 during inflation.

The distal force control module 600 further includes a fluidic member 630 for inflating the first elastomeric member 610 and second elastomeric member 620. The fluidic member 630 is fluidically connected to the pneumatic system 300. The controller module 530 is configured for controlling the distal force control modules 600, particularly to control the pneumatic system 300 to inflate the elastomeric members 610,620. The distal force control module 600 may include a cover layer 640 for attaching to the distal section 520. For example, the cover layer 640 is a thin piece of fabric that is sewn to the glove 510.

When the distal force control module 600 is inflated, the first elastomeric member 610 expands in an indentation direction that is normal to the distal end of the digit section 520. Due to the difference on modulus of elasticity, the second elastomeric member 620 remains stiff or expands to a lesser extent. By controlling the inflation pressure and frequency, the skin indentation can be controlled, thereby generating variable force and vibration to the user's fingertip at the distal end of the digit section 520.

The force control modules 100 (also referred to as “PneuClutch”) are configured to deliver kinaesthetic feedback, while the distal force control modules 600 (also referred to as “PneuIndenter”) are configured to deliver cutaneous feedback via skin indentation. Kinaesthetic and cutaneous perceptions are two types of touch sensations received by mechanoreceptors in response to mechanical stimuli, allowing people to feel the shape, softness, texture, and weight of objects and manipulate them stably and precisely in daily life.

Several tests were conducted to evaluate the performance of the wearable device 500 including the force control modules 100 and distal force control modules 600.

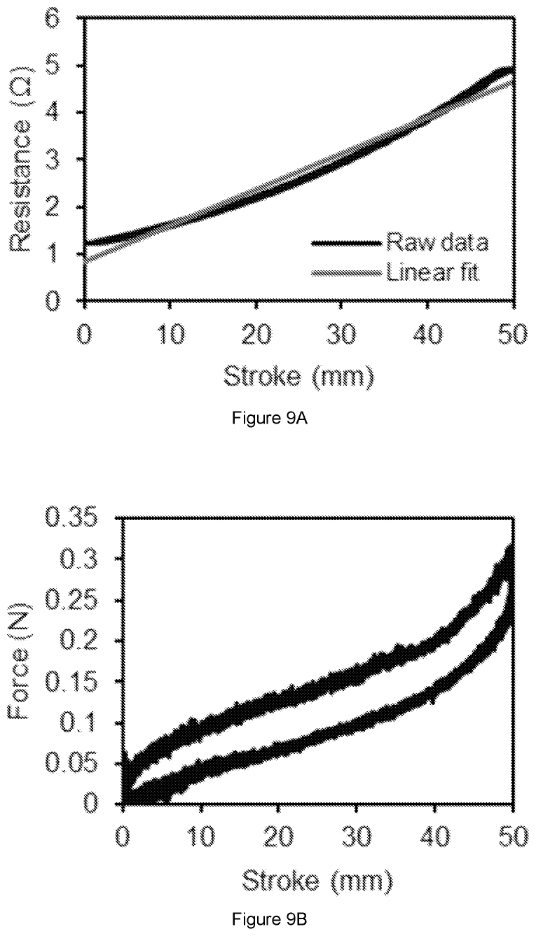

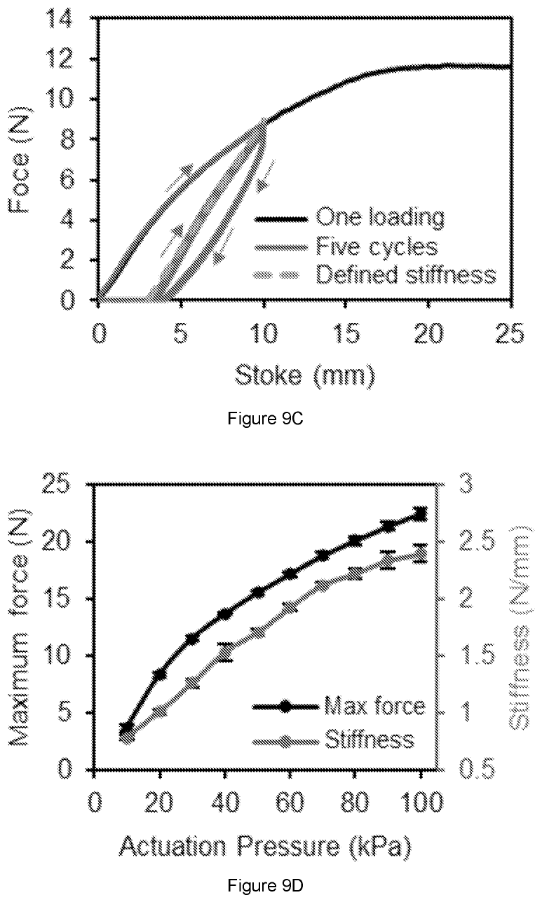

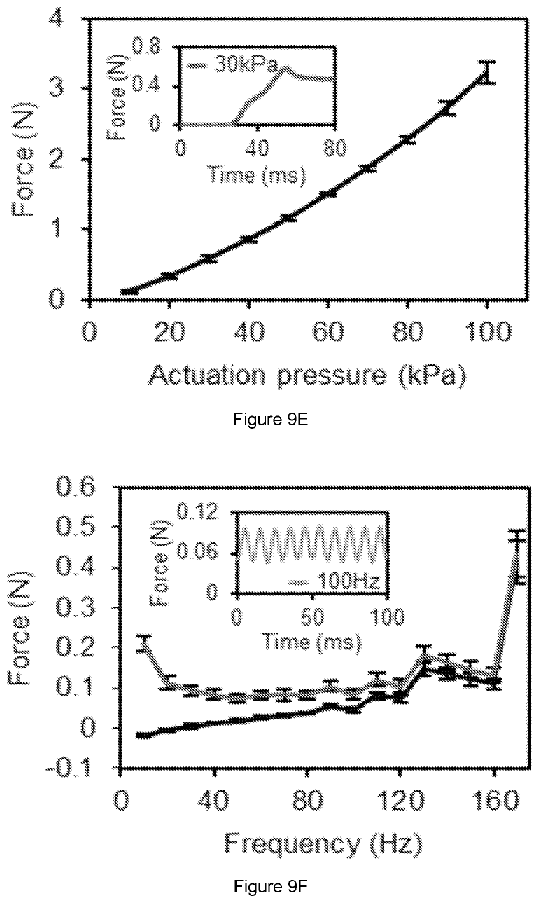

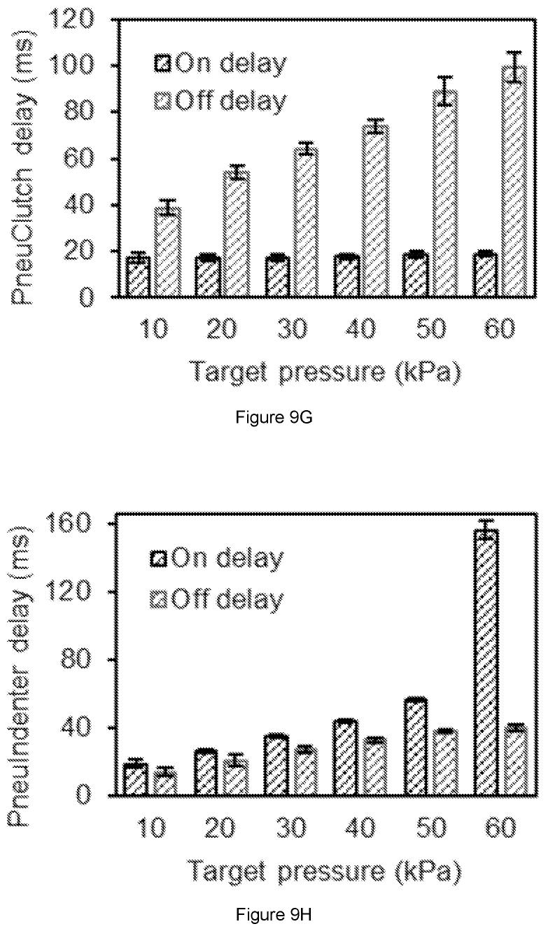

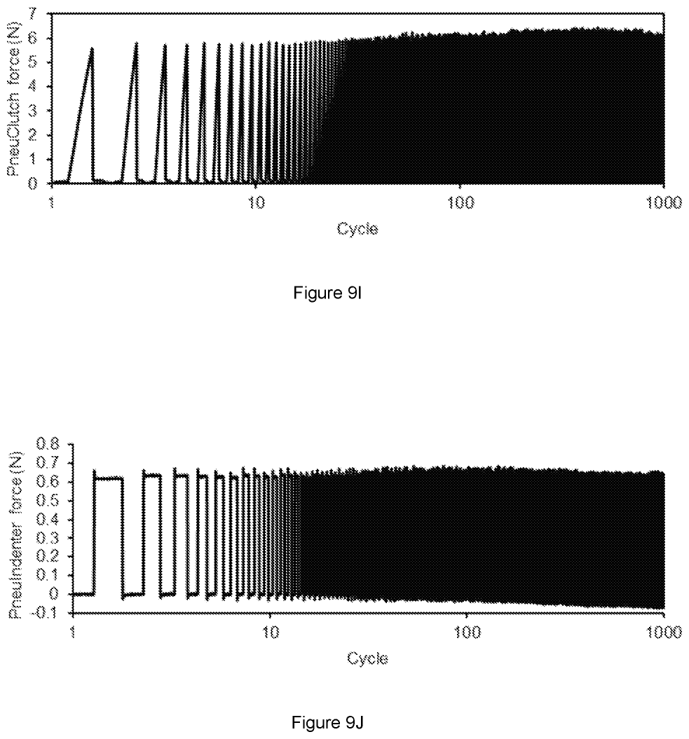

When the cable 160 of the force control module 100 is pulled (actuation stroke), the electrical resistance of the rotational sensor is positively correlated with the stroke, as shown in FIG. 9A. The electrical resistance ranges from 1.24 0 to 4.92 Q with negligible hysteresis and good linearity, indicating stable rotation sensing capability.

Even when haptics is not applied, the cable 160 experiences an actuation force because of the elasticity of the elastic member 170. As the elastic member 160 is thin and highly stretchable, the actuation force changes smoothly as shown in FIG. 9B. The maximum resistive force is about 0.32N, which is nearly unperceivable by the user.

The force control module 100 was actuated to a pressure of 30 kPa. As shown in FIG. 9C, under a 25 mm stroke, the actuation force increases to a maximum of 11.7 N. Under five loading cycles with a 10 mm stroke, significant hysteresis was observed in the first loading cycle, while the force profile in the rest of the loading cycles became consistent with a smaller hysteresis. This was because in the first loading cycle, the contact area of the elastomeric part 130 gradually slid as the stroke increased, which prevented the rotational parts 120 from rotating back to the original position during unloading. No further sliding was observed in the following loading cycles with the same stroke. The force feedback stiffness is defined as the slope of the linear line fit to the force data points during loading after the first loading cycle, which is about 1.25 N/mm for 30 kPa actuation pressure.

The force control module 100 was actuated to a pressure from 10 kPa to 100 kPa with 10 kPa increment. As shown in FIG. 9D, the maximum actuation force increased from 3.65 N to 22.41 N with increasing actuation pressure. The stiffness ranged from 0.78 N/mm to 2.39 N/mm, indicating a variable stiffness capability by regulating the actuation pressure. The error bars are the standard deviations based on three force control modules 100, and each force control module 100 performed three repetitive tests. There was consistent performance among different force control modules 100 and tests, demonstrating reliable force feedback to the fingers.

The distal force control module 600 was actuated to a pressure from 10 kPa to 100 kPa with 10 kPa increment. As shown in FIG. 9E, the maximum actuation force increased from 0.11 N to 3.23 N with increasing actuation pressure, thereby providing variable force feedback at the fingertips. The inset in FIG. 9E shows the measured force over time under 30 kPa actuation pressure. The distal force control module 600 was able to respond quickly to changes in actuation pressure.

The distal force control module 600 was actuated at frequencies from 10 Hz to 170 Hz. As shown in FIG. 9F, the difference between the peak and valley forces reduced with increasing actuation frequency, because the pressurized air was delivered to and exhausted from the distal force control module 600 within a shorter time. When the actuation frequency was above 160 Hz, there was insufficient time for the air to be exhausted. There was a larger error bar at 170 Hz, indicating that the fingertip feedback is less reliable. Therefore, the distal force control module 600 can provide stable haptic feedback at the fingertips at actuation frequencies of up to 160 Hz. The inset in FIG. 9F shows a consistent force feedback profile at 100 Hz.

The haptic on/off delays were measured for the force control module 100 and distal force control module 600, as shown in FIGS. 9G and 9H, respectively. The force control module 100 took about 18 ms to be activated regardless of target pressure, but required more time to release, ranging from 38.8 ms to 99.4 ms with increasing target pressure. The haptic on delay for the distal force control module 600 was about 18.8 ms to 155.9 ms with increasing target pressure, while the haptic off delay was about 14.1 ms to 40.3 ms with increasing target pressure. The haptic on delay is shorter for the force control module 100 than the distal force control module 600 because the force control module 100 is closer to the pneumatic system 300 with smaller pneumatic resistance. The haptic off delay is shorter for the distal force control module 600 than the force control module 600 because the indentation force at the fingertip accelerates the air exhaustion.

The force control module 100 and distal force control module 600 were repetitively tested over 1000 cycles at the same actuation pressure to evaluate the haptic feedback consistency over time. As shown in FIGS. 91 and 9J, respectively, there were consistent feedback forces, indicating the long-term reliability of the force control modules 100 and distal force control modules 600 for both kinaesthetic and cutaneous feedback.

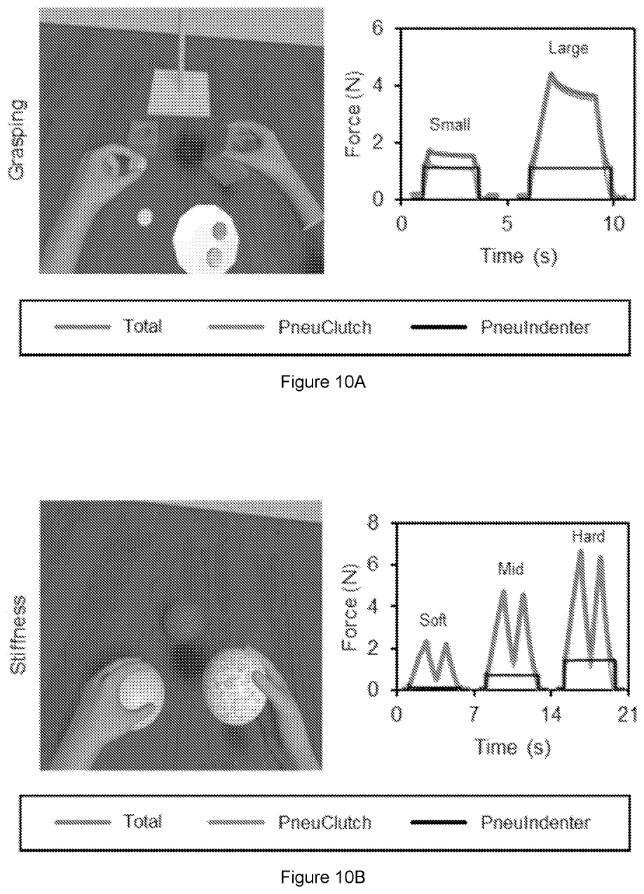

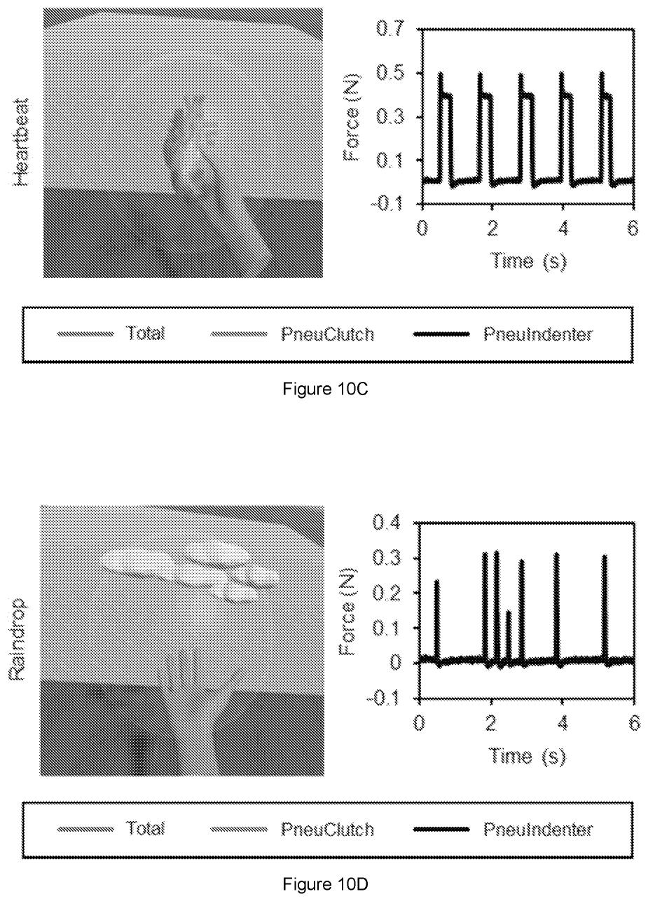

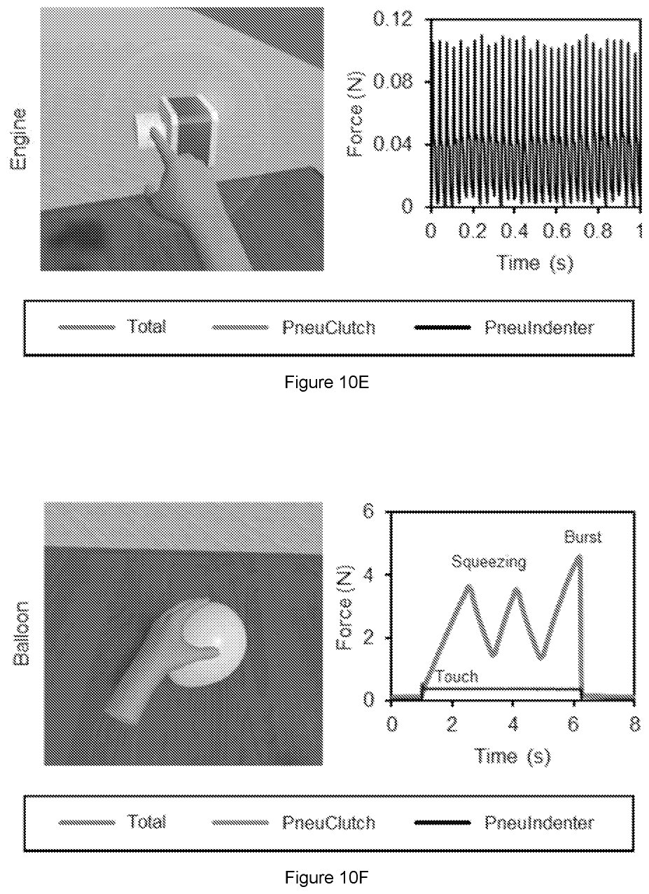

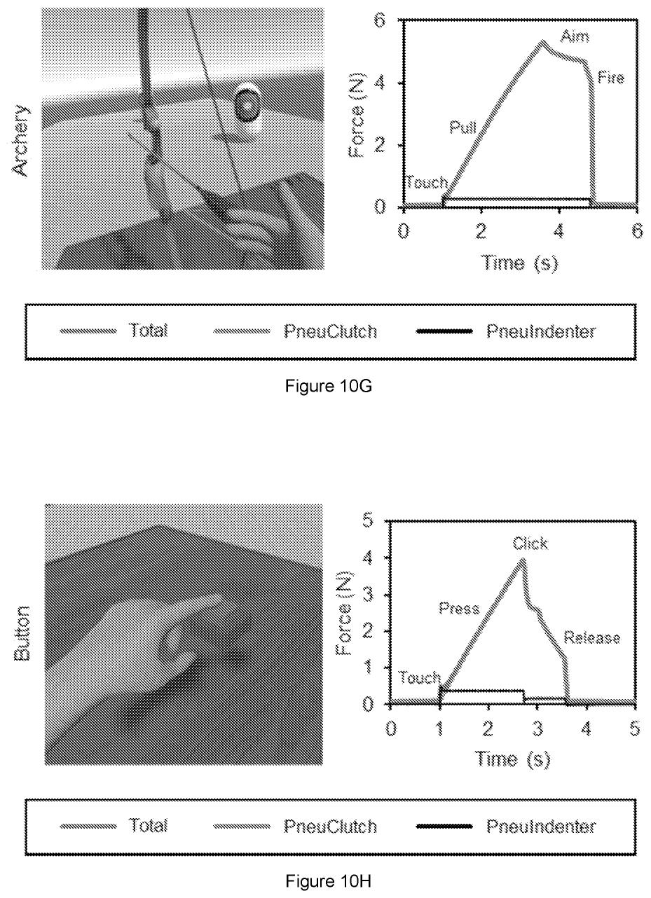

The wearable device 500 was also tested in some virtual reality applications to evaluate the multimode haptic feedback performance. Finger calibration was done for accurate and consistent finger tracking among different users. FIGS. 10A to 10H illustrate the different virtual reality applications and the corresponding feedback forces.

FIG. 10A shows the grasping large and small virtual objects. The virtual objects were designed to be fairly rigid and grasped with 50 kPa actuation pressure. Contact sensation was felt by the user as the virtual hand touches the virtual object, which is the cutaneous feedback provided by the distal force control modules 600. When the user grasps and holds the virtual object, kinaesthetic feedback is felt from the force control modules 100 and the cutaneous feedback is restricted at the surface of the virtual object.

FIG. 10B shows the manipulation of virtual objects with different stiffness, which is achieved using three actuation pressures—10 kPa, 35 kPa, and 55 kPa—to distributism between soft and hard objects. The force profiles in FIG. 10B show that the soft object provides softer cutaneous feedback and is easier to squeeze with smaller actuation force. In addition, a smooth increasing and decreasing force according to the user squeezing creates a realistic touch sensation of elastic objects.

FIG. 10C shows the wearable device 500 rendering the cutaneous feedback of a beating heart by controlling the actuation frequency at 0.83 Hz and the actuation pressure at 20 kPa.

FIG. 10D shows virtual reality application of mimicking raindrops falling on the user's fingertips. The sensation was achieved by randomly activating the distal force control modules 600 for 100 ms at an actuation frequency of 3 Hz and with random actuation pressures from 10 kPa to 20 kPa.

FIG. 10E shows virtual reality application of mimicking the sensation of touching a vibrating motor by controlling the actuation frequency of the distal force control module 600 for the index finger at 30 Hz.

FIG. 10F shows a virtual balloon with 20 kPa actuation pressure. The users felt the contact and elasticity of the balloon when touching and squeezing the balloon. When the users squeeze hard, the balloon bursts and the haptics are released simultaneously, creating a realistic bursting sensation.

FIG. 10G shows a virtual archery game that allowed the users to feel the string tension when shooting arrows. The users first felt their index, middle, and ring fingers touch the string. The users then felt the increasing tension when they flex their fingers while pulling the string. After aiming at the target, a small finger extension fires the arrow, and the haptics are released simultaneously.

FIG. 10H shows a virtual button with changing actuation pressure according to the user's pressing of the button. When the index finger touched the button, the corresponding force control module 100 and distal force control module 600 are activated at 25 kPa actuation pressure. This allowed the user to feel the contact and the button resistance when pressing it by flexing the index finger. At the point when the button is pressed, half of the air inside the force control module 100 and distal force control module 600 is exhausted, causing a sudden drop of both kinaesthetic and cutaneous feedback, which mimics the click sensation. Then, as the user continuously extended the index finger to release the button, a corresponding decreasing force is felt until the index finger has completely left the button.

User studies were conducted to evaluate if the wearable device 500 can provide multimode haptic feedback effectively and if the haptic feedback improves the user experience in virtual reality applications. 19 participants (11 male and 8 female) were recruited, with age ranging from 21 to 41. Two wearable devices 500 with different sizes of the gloves 510 were prepared. The participants wore a suitably sized wearable device 500 on their dominant hand, and put on noise-cancelling headphones playing white noise to block out sound from the wearable device 500 and the environment that may affect their perception of the haptic feedback. The participants then wore VR headset to display a rendered virtual reality environment.

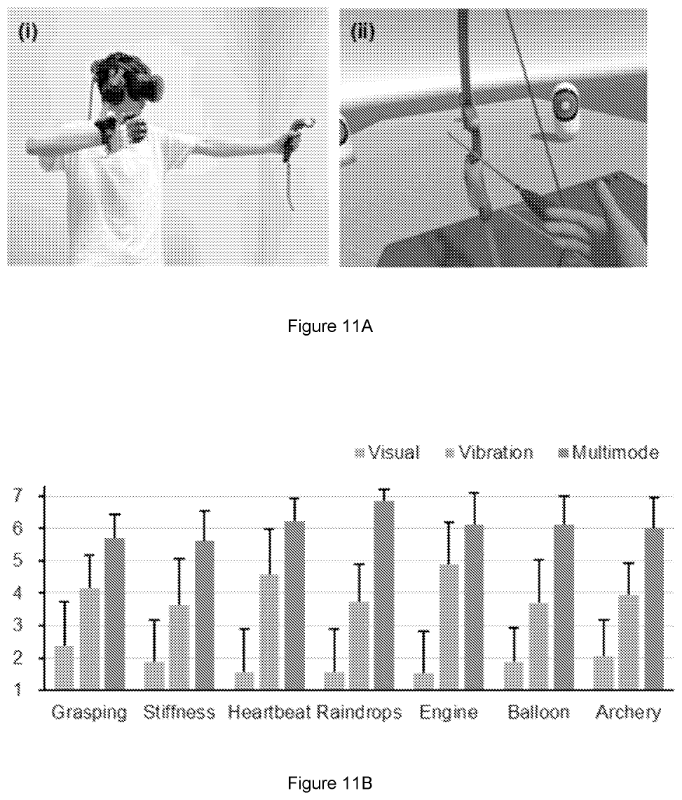

The first study evaluated haptic feedback realism. The participants experienced the seven virtual reality seven scenarios (as shown in FIGS. 10A to 10G) under three conditions—no haptics (visual only), vibration motor haptics (using eccentric rotating mass vibration motors and controlled with pulse width modulation), and multimode haptics (using the wearable device 500). For example, FIG. 11A shows a participant playing the archery game of FIG. 10G. The user experiences were evaluated using a 7-point Likert scale, with 1 indicating most unrealistic and 7 indicating most realistic.

As shown in FIG. 11B, it was found that vibration feedback improved the realism experience compared to just visual, but multimode haptics made the experience significantly more realistic. In the grasping scenario of FIG. 10A, the kinaesthetic feedback restricted participants' fingers at the object's surface, causing much less penetration inside the virtual objects and making grasping more realistic (mean 5.68, standard deviation 0.75). In the stiffness sensing scenario of FIG. 10B, the variable stiffness capability under the multimode condition realistically recreated different elasticities of the virtual objects (mean 5.63, standard deviation 0.90), while under the vibration condition, different stiffnesses were expressed by magnitude of vibration which lacked fidelity. For the heartbeat scenario of FIG. 10C, most of the participants felt the multimode condition was more realistic (mean 6.21, standard deviation 0.71), but 10.5% of participants preferred the vibration condition because the motors vibrated a much larger area which gave them an illusion that they were holding a big heart that vibrated as a whole.

The raindrops scenario of FIG. 10D was rated as the most realistic for the multimode condition because of the sharp and localized cutaneous feedback. The multimode rating (mean 6.87, standard deviation 0.37) is 83.4% higher than the vibration rating (mean 3.47, standard deviation 1.15). 47.3% of participants rated the raindrops scenario as their favourite because of the realistic feeling. For the engine scenario of FIG. 10E, 68.4% of participants rated the multimode condition as more realistic (mean 6.11, standard deviation 0.99) because the 30 Hz force feedback made them feel the engine rotor was continuously hitting their fingertip. In the balloon scenario of FIG. 10F, the multimode rating (mean 6.11, standard deviation 0.88) is 66% higher than the vibration rating (mean 3.68, standard deviation 1.34) because the kinaesthetic feedback and fast response accurately recreated the balloon elasticity and the bursting sensation. For the archery scenario of FIG. 10G, the feeling of the string tension and arrow release from kinaesthetic feedback made this scenario more realistic under the multimode condition (mean 6, standard deviation 0.94). In addition, 26.3% of participants considered the archery scenario as their favourite, making it the second most popular scenario.

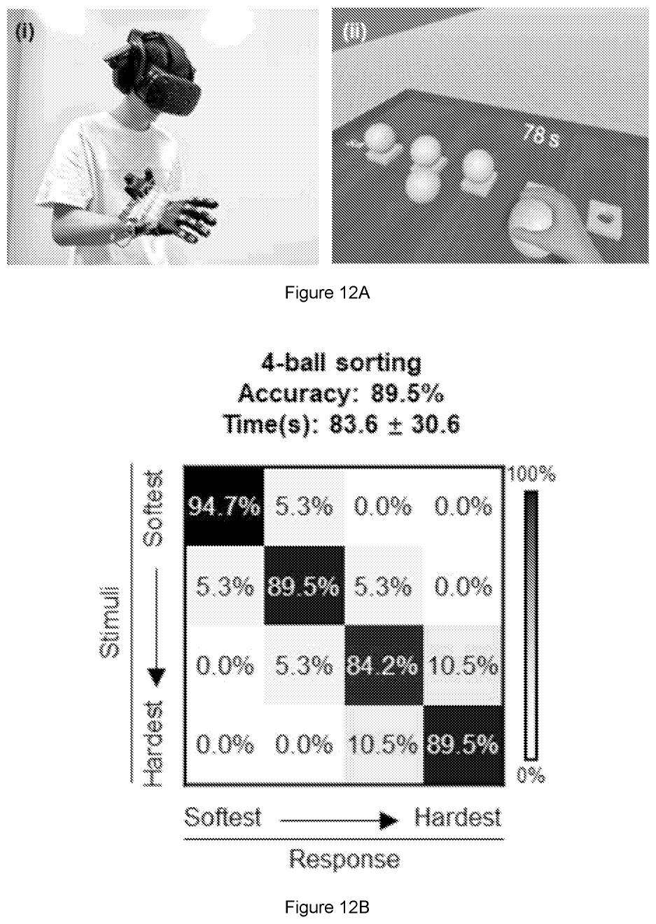

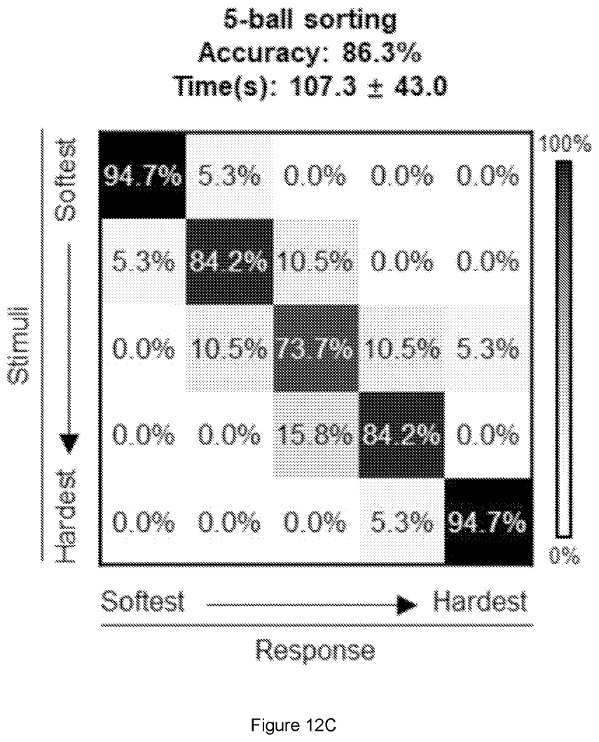

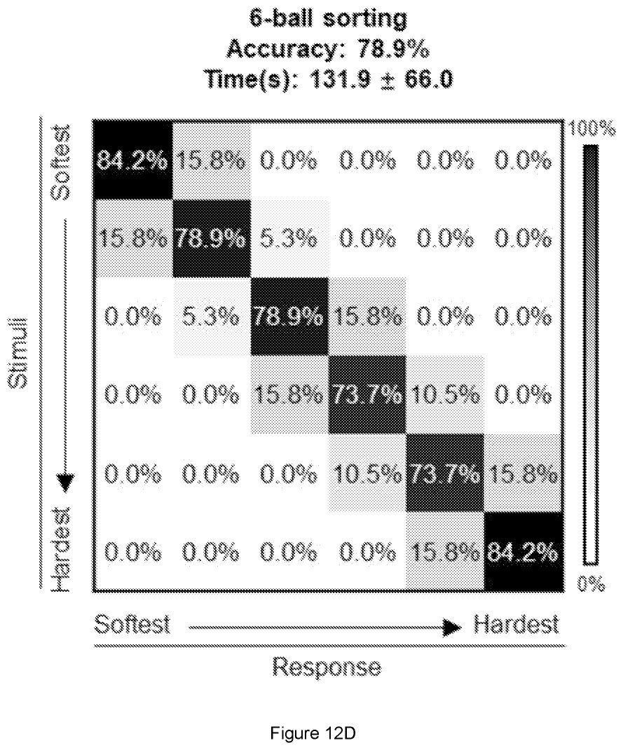

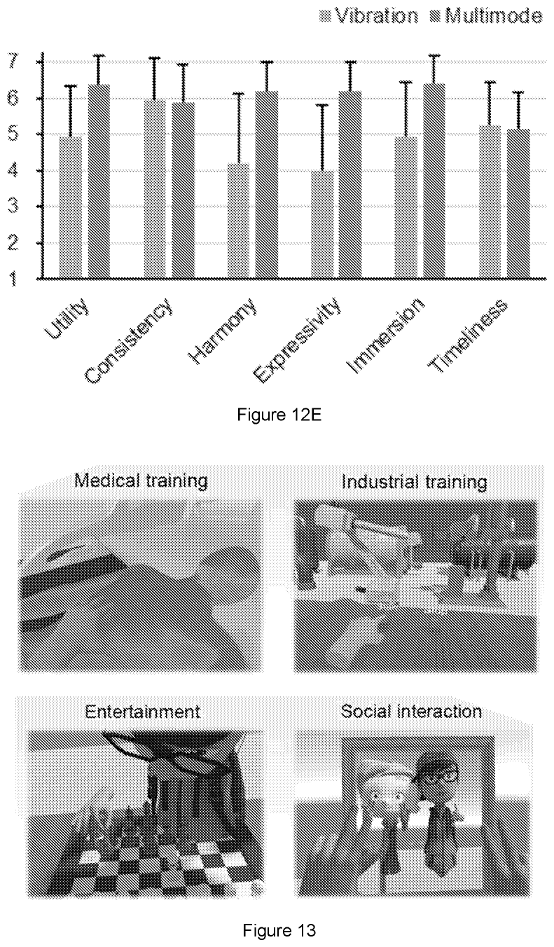

The second study quantitatively evaluated the effectiveness of rendering soft and hard virtual objects by performing virtual ball sorting under the vibration and multimode conditions. As shown in FIG. 12A, a set of visually identical virtual balls with random stiffnesses were presented on a virtual table. The softest and hardest balls were equivalent to 10 kPa and 60 kPa actuation pressure, respectively. The actuation pressure for other balls was assigned with an equal difference. Participants continuously performed one 4-ball sorting, one 5-ball sorting, and one 6-ball sorting. For each sorting, they were asked to finish within 2 minutes. The participants were then given a questionnaire to evaluate their haptics experience. Specifically, the participants evaluated utility (is it useful?), consistency (is it reliable?), harmony (does it fit with visual sense?), expressivity (Is there distinction between haptic objects?), immersion (do you feel engaged?), and timeliness (how timely is the haptics delivery?). The user experiences were evaluated using a 7-point Likert scale, with 1 indicating most negative and 7 indicating most positive.

As shown in FIGS. 12B to 12D, it was found that the average time to finish 4-ball sorting is 83.6 s with an average accuracy of 89.5%. 79.9% of participants successfully sorted all 4 balls correctly. The average time to finish 5-ball sorting is 107.3 s with an average accuracy of 86.3%. The average time to finish 6-ball sorting is 131.9 s with an average accuracy of 78.9%. The time increased and the accuracy dropped when the number of balls increased, as participants tended to spend more time and make slightly more errors with more balls of varying stiffness. The average accuracy is still high even for 6-ball sorting, indicating the capability to render multiple levels of stiffness for virtual objects.

As shown in FIG. 12E, paired t-test was performed for analysing the questionnaire results. It was observed that there were positive ratings for consistency (p=0.587) and timeliness (p=0.675), indicating that the wearable device 500 was reliable and fast-actuated compared with ERM vibration motors. Both haptic feedback conditions were rated as useful but the multimode condition (mean 6.36, standard deviation 0.83) was significantly more useful (p<0.001) than the vibration condition (mean 4.94, standard deviation 1.39) because of the high fidelity provided. The vibration condition (mean 4.21, standard deviation 1.93) is significantly less harmonious (p<0.001) than the multimode condition (mean 6.21, standard deviation 0.78). Some participants commented that vibration condition was not aligned with their visual sense because they did not expect virtual balls to vibrate when they touched them. The multimode condition (mean 6.21, standard deviation 0.78) showed significantly more expressivity (p<0.001) because the wearable device 500 created richer haptic feedback with distinctive haptics sensing. The multimode condition (mean 6.42, standard deviation 0.769) also provided a significantly more immersive VR user experience (p<0.001).

The user studies showed that wearable device 500 provided consistent and timely multimode haptic feedback and delivered a much more realistic touch sensation, which significantly improves VR user experiences. In addition, 78.9% of participants commented the weight of the wearable device 500 (about 283 g) was acceptable, and some commented that the weight was unnoticeable when immersed in VR scenarios.

The wearable devices 200,500 can thus provide a virtual reality haptic glove capable of delivering five-finger variable stiffness force feedback during manipulation of virtual objects. The wearable devices 200,500 are able to monitor movement of individual fingers continuously and generate variable stiffness haptic feedback when needed, allowing the user to touch and feel virtual objects from soft to rigid. The wearable devices 200,500 provides the user with a natural and realistic sense of touch and an immersive experience in virtual reality.

The wearable devices 200,500 use small lightweight pneumatic components that contribute to a lightweight and compact pneumatic system 300. Additionally, the pneumatic system 300 delivers low actuation pressure for safer operation by the user. The wearable devices 200,500 provide timely and realistic multimode haptic feedback, including both kinaesthetic and cutaneous sensations, achieved by the low-pressure actuated lightweight components. When actuated, the force control modules 100 and distal force control modules 600 can be kept at the delivered pressure without consuming any power, thus improving overall energy efficiency. However, it will be appreciated that the wearable devices 200,500 can be modified to deliver higher actuation pressures to increase the maximum actuation force and maximum stiffness. For example, the wearable devices 200,500 may be modified with different configurations and/or materials to deliver different range of actuation pressures to suit different applications. As highlighted by the various experiments and studies described above, the force control modules 100 and distal force control modules 600 can provide low-latency haptic feedback for the user, making the wearable devices 200,500 suitable for applications in computer simulated environments such as virtual reality and augmented reality. The experiments and studies have demonstrated that the wearable devices 200,500 provide variable stiffness force feedback and fingertip force feedback, allowing users manipulate various virtual objects and feel the dynamic haptic changes., thereby enhancing enhanced the user experience.

Moreover, the wearable device 200 can find applications in other areas, such as for training, rehabilitation, etc. For example, in medical education, meaningful information can be conveyed through touch sensations, such as via palpations. The wearable devices 200,500 have the potential to be implemented to enable “physical” touching of virtual patients and feeling of human tissue stiffness during VR medical training. This facilitates a decentralized VR medical training platform where trainees can perform realistic training procedures remotely and communicate with instructors in real-time. The wearable devices 200,500 can also be used for VR industrial training and simulation, where buttons and tools can be felt with haptic feedback for effective learning and training experiences. The wearable devices 200,500 can be used for hand rehabilitation to train patients' hand-eye coordination and improve finger strength and range of motion. With gamified training content, patients can be more motivated to practice.

FIG. 13 shows various possible applications of the wearable devices 200,500 in a reality-virtuality continuum, such as medical training, industrial training, entertainment, and social interaction. For example, a two-player chess game demonstrates scenarios for users to pick up and feel chess pieces, and even feel physical contact with each other through handshakes. For example, social interactions with multiple users can be achieved, beyond the conventional single-person interaction with virtual objects. The wearable devices 200,500 improve the sense of touch that can enhance social interaction in the emerging metaverse.

### Additive Manufacturing

The force control module 100 or distal force control module 600 or parts thereof can be fabricated by various manufacturing methods, such as injection moulding, laser cutting, and CNC machining. In some embodiments, the force control module 100 and distal force control module 600 or parts thereof or a product comprising the force control module 100 and distal force control module 600 or parts thereof may be formed by a manufacturing process that includes an additive manufacturing process. A common example of additive manufacturing is three-dimensional (3D) printing; however, other methods of additive manufacturing are available. Rapid prototyping or rapid manufacturing are also terms which may be used to describe additive manufacturing processes.

As used herein, “additive manufacturing” refers generally to manufacturing processes wherein successive layers of material(s) are provided on each other to “build-up” layer-by-layer or “additively fabricate”, a 3D component. This is compared to some subtractive manufacturing methods (such as milling or drilling), wherein material is successively removed to fabricate the part. The successive layers generally fuse together to form a monolithic component which may have a variety of integral sub-components. In particular, the manufacturing process may allow an example of the disclosure to be integrally formed and include a variety of features not possible when using prior manufacturing methods.

Additive manufacturing methods described herein enable manufacture to any suitable size and shape with various features which may not have been possible using prior manufacturing methods. Additive manufacturing can create complex geometries without the use of any sort of tools, moulds, or fixtures, and with little or no waste material. Instead of machining components from solid billets of plastic or metal, much of which is cut away and discarded, the only material used in additive manufacturing is what is required to shape the part.

Suitable additive manufacturing techniques in accordance with the present disclosure include, for example, Fused Deposition Modelling (FDM), Selective Laser Sintering (SLS), 3D printing such as by inkjets and laserjets, Stereolithography (SLA), Direct Selective Laser Sintering (DSLS), Electron Beam Sintering (EBS), Electron Beam Melting (EBM), Laser Engineered Net Shaping (LENS), Electron Beam Additive Manufacturing (EBAM), Laser Net Shape Manufacturing (LNS), Direct Metal Deposition (DMD), Digital Light Processing (DLP), Continuous Digital Light Processing (CDLP), Direct Selective Laser Melting (DSLM), Selective Laser Melting (SLM), Direct Metal Laser Melting (DMLM), Direct Metal Laser Sintering (DMLS), Material Jetting (MJ), NanoParticle Jetting (NPJ), Drop On Demand (DOD), Binder Jetting (BJ), Multi Jet Fusion (MJF), Laminated Object Manufacturing (LOM), and other known processes.

The additive manufacturing processes described herein may be used for forming components using any suitable material. For example, the material may be metal, plastic, polymer, composite, or any other suitable material that may be in solid, liquid, powder, sheet material, wire, or any other suitable form or combinations thereof. More specifically, according to exemplary embodiments of the present disclosure, the additively manufactured components described herein may be formed in part, in whole, or in some combination of materials suitable for use in additive manufacturing processes and which may be suitable for the fabrication of examples described herein.

As noted above, the additive manufacturing process disclosed herein allows a single component to be formed from multiple materials. Thus, the examples described herein may be formed from any suitable mixtures of the above materials. For example, a component may include multiple layers, segments, or parts that are formed using different materials, processes, and/or on different additive manufacturing machines. In this manner, components may be constructed which have different materials and material properties for meeting the demands of any particular application. In addition, although the components described herein are constructed entirely by additive manufacturing processes, it should be appreciated that in alternate embodiments, all or a portion of these components may be formed via casting, machining, and/or any other suitable manufacturing process. Indeed, any suitable combination of materials and manufacturing methods may be used to form these components.

Additive manufacturing processes typically fabricate components based on 3D information, for example a 3D computer model (or design file), of the component. Accordingly, examples described herein not only include products or components as described herein, but also methods of manufacturing such products or components via additive manufacturing and computer software, firmware or hardware for controlling the manufacture of such products via additive manufacturing.

The structure of the product may be represented digitally in the form of a design file. A design file, or computer aided design (CAD) file, is a configuration file that encodes one or more of the surface or volumetric configuration of the shape of the product. That is, a design file represents the geometrical arrangement or shape of the product.

Design files can take any now known or later developed file format. For example, design files may be in the Stereolithography or “Standard Tessellation Language” (.stl) format which was created for Stereolithography CAD programs of 3D Systems, or the Additive Manufacturing File (amf) format, which is an American Society of Mechanical Engineers (ASME) standard that is an extensible markup-language (XML) based format designed to allow any CAD software to describe the shape and composition of any 3D object to be fabricated on any additive manufacturing printer. Further examples of design file formats include AutoCAD (.dwg) files, Blender (.blend) files, Parasolid (.x_t) files, 3D Manufacturing Format (0.3mf) files, Autodesk (3ds) files, Collada (.dae) files and Wavefront (.obj) files, although many other file formats exist.

Design files can be produced using modelling (e.g. CAD modelling) software and/or through scanning the surface of a product to measure the surface configuration of the product. Once obtained, a design file may be converted into a set of computer executable instructions that, once executed by a processer, cause the processor to control an additive manufacturing apparatus to produce a product according to the geometrical arrangement specified in the design file. The conversion may convert the design file into slices or layers that are to be formed sequentially by the additive manufacturing apparatus. The instructions (otherwise known as geometric code or “G-code”) may be calibrated to the specific additive manufacturing apparatus and may specify the precise location and amount of material that is to be formed at each stage in the manufacturing process. As discussed above, the formation may be through deposition, through sintering, or through any other form of additive manufacturing method.

The code or instructions may be translated between different formats, converted into a set of data signals and transmitted, received as a set of data signals and converted to code, stored, etc., as necessary. The instructions may be an input to the additive manufacturing system and may come from a part designer, an intellectual property (IP) provider, a design company, the operator or owner of the additive manufacturing system, or from other sources. An additive manufacturing system may execute the instructions to fabricate the product using any of the technologies or methods disclosed herein.

Design files or computer executable instructions may be stored in a (transitory or non-transitory) computer readable storage medium (e.g., memory, storage system, etc.) storing code, or computer readable instructions, representative of the product to be produced. As noted, the code or computer readable instructions defining the product that can be used to physically generate the object, upon execution of the code or instructions by an additive manufacturing system. For example, the instructions may include a precisely defined 3D model of the product and can be generated from any of a large variety of well-known CAD software systems such as AutoCAD®, TurboCAD®, DesignCAD 3D Max, etc. Alternatively, a model or prototype of the product may be scanned to determine the 3D information of the product. Accordingly, by controlling an additive manufacturing apparatus according to the computer executable instructions, the additive manufacturing apparatus can be instructed to print out the product.

In light of the above, embodiments include methods of manufacture via additive manufacturing. This includes the steps of obtaining a design file representing the product and instructing an additive manufacturing apparatus to manufacture the product according to the design file. The additive manufacturing apparatus may include a processor that is configured to automatically convert the design file into computer executable instructions for controlling the manufacture of the product. In these embodiments, the design file itself can automatically cause the production of the product once input into the additive manufacturing apparatus. Accordingly, in this embodiment, the design file itself may be considered computer executable instructions that cause the additive manufacturing apparatus to manufacture the product. Alternatively, the design file may be converted into instructions by an external computing system, with the resulting computer executable instructions being provided to the additive manufacturing apparatus.

Given the above, the design and manufacture of implementations of the subject matter and the operations described in this specification can be realized using digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

Although additive manufacturing technology is described herein as enabling fabrication of complex objects by building objects point-by-point, layer-by-layer, typically in a vertical direction, other methods of fabrication are possible and within the scope of the present subject matter. For example, although the discussion herein refers to the addition of material to form successive layers, one skilled in the art will appreciate that the methods and structures disclosed herein may be practiced with any additive manufacturing technique or other manufacturing technology.

In the foregoing detailed description, embodiments of the present disclosure in relation to a force control module and a wearable device comprising the force control module are described with reference to the provided figures. The description of the various embodiments herein is not intended to call out or be limited only to specific or particular representations of the present disclosure, but merely to illustrate non-limiting examples of the present disclosure. The present disclosure serves to address at least one of the mentioned problems and issues associated with the prior art. Although only some embodiments of the present disclosure are disclosed herein, it will be apparent to a person having ordinary skill in the art in view of this disclosure that a variety of changes and/or modifications can be made to the disclosed embodiments without departing from the scope of the present disclosure. Therefore, the scope of the disclosure as well as the scope of the following claims is not limited to embodiments described herein.

1. A force control module comprising:
at least one fixed part;
at least one rotational part aligned to the fixed part and rotatable about a rotational axis of the fixed part; and
an elastomeric part disposed within one of the fixed part and rotational part, the elastomeric part separated from an inner surface of the one of the fixed part and rotational part, the elastomeric part coupled to the rotational part such that the elastomeric part is rotatable by the rotational part about the rotational axis,
wherein the elastomeric part is actuatable towards the inner surface to generate a variable actuation force on the inner surface, the variable actuation force for resisting rotation of the rotational part.

2. (canceled)

3. The force control module according to claim 1, further comprising a set of inlets for inflating the elastomeric part towards the inner surface.

4. The force control module according to claim 1, further comprising a cable coupled to the rotational part for rotating the rotational part.

5. The force control module according to claim 1, further comprising an elastic member coupled to the fixed part and the rotational part, the elastic member configured to bias the rotational part to an initial position before rotation thereof.

6. The force control module according to claim 5, wherein the elastic member comprises a rotational sensor for measuring an angle of the rotation.

7. A wearable device comprising:
a glove comprising a plurality of digit sections;
a plurality of force control modules, each force control module coupled to a respective one of the digit sections and comprising:
at least one fixed part;
at least one rotational part aligned to the fixed part and rotatable about a rotational axis of the fixed part;
an elastomeric part disposed within one of the fixed part and rotational part, the elastomeric part separated from an inner surface of the one of the fixed part and rotational part, the elastomeric part coupled to the rotational part such that the elastomeric part is rotatable by the rotational part about the rotational axis; and
a cable coupled to the rotational part and the respective digit section for rotating the rotational part in response to movement of the respective digit section; and
a controller module configured for controlling the force control modules to actuate the elastomeric parts towards the inner surfaces to generate variable actuation forces on the inner surfaces, the variable actuation forces for resisting rotations of the elastomeric parts,
wherein the resisted rotations of the rotational parts in response to movement of the digit sections generate haptic feedback in the digit sections.

8. The wearable device according to claim 7, further comprising a pneumatic system coupled to the force control modules and controllable by the controller module for inflating the elastomeric parts to engage with the inner surfaces.

9. The wearable device according to claim 8, wherein the pneumatic system comprises a plurality of pneumatic modules, each pneumatic module coupled to a respective one of the force control modules for inflating the respective elastomeric part.

10. The wearable device according to claim 9, wherein the pneumatic system further comprises a chamber for storing pressurized fluid and communicating the pressurized fluid from the chamber to the pneumatic modules, and wherein the chamber is optionally configured to maintain a predetermined pressure therein.

11. (canceled)

12. The wearable device according to claim 9, wherein each pneumatic module comprises an inlet valve and an outlet valve for regulating communication of pressurized fluid to the respective force control module.

13. The wearable device according to claim 7, further comprising a tracking device for tracking movement of the glove.

14. The wearable device according to claim 13, wherein the controller module and tracking device are configured for communicating with a computer system, and wherein the controller module is optionally configured for receiving haptic signals from the computer system and controlling actuation of the elastomeric parts based on the haptic signals.

15. (canceled)

16. The wearable device according to claim 14, wherein the controller module and tracking device are configured for transmitting movement data to the computer system based on movement of the digit sections.

17. The wearable device according to claim 7, wherein each force control module further comprises an elastic member coupled to the fixed part and the rotational part, the elastic member configured to bias the rotational part to an initial position before rotation thereof.

18. The wearable device according to claim 17, wherein the elastic member comprises a rotational sensor for measuring an angle of the rotation.

19. The wearable device according to claim 7, further comprising a plurality of distal force control modules, each distal force control module coupled to a distal end of a respective one of the digit sections.

20. The wearable device according to claim 19, wherein each distal force control module comprises a first elastomeric member and a second elastomeric member that are joined together, and wherein each distal force control module optionally comprises a fluidic member for inflating the first and second elastomeric members.

21. (canceled)

22. The wearable device according to claim 20, wherein the first and second elastomeric members have different modulus of elasticity, such that the first elastomeric member expands more than the second elastomeric member during inflation.

23. A computer program comprising computer executable instructions that, when executed by a processor, cause the processor to control an additive manufacturing apparatus to manufacture a product comprising the force control module according to claim 1.

24. A method of manufacturing a product via additive manufacturing, the method comprising:
obtaining an electronic file representing a geometry of the product wherein the product comprises the force control module according to claim 1; and
controlling an additive manufacturing apparatus to manufacture, over one or more additive manufacturing steps, the product according to the geometry specified in the electronic file.
